(19) United States
(12) Patent Application Publication
(10) Pub. No.: US 2013/0339930 A1
(43) Pub. Date: Dec. 19, 2013

(54) MODEL-BASED TEST CODE GENERATION FOR SOFTWARE TESTING

(71) Applicant: Dianxiang Xu, Sioux Falls, SD (US)

(72) Inventor: Dianxiang Xu, Sioux Falls, SD (US)

(73) Assignee: South Dakota Board of Regents

(21) Appl. No.: 13/525,824

(22) Filed: Jun. 18, 2012

(51) Int. Cl. G06F 11/36

(52) U.S. Cl. 717/125

(57) ABSTRACT

A method of creating test code automatically from a test model is provided. In the method, an indicator of an interaction by a user with a user interface window presented in a display of a computing device is received. The indicator indicates that a test model definition is created. A mapping window includes a first column and a second column. An event identifier is received in the first column and text mapped to the event identifier is received in the second column. The event identifier defines a transition included in the test model definition and the text defines code implementing a function of a system under test associated with the transition in the mapping window. A code window is presented in the display. Helper code text is received. The helper code text defines second code to generate executable code from the code implementing the function of the system under test. Executable test code is generated using the code implementing the function of the system under test and the second code.

### REFERENCE TO GOVERNMENT RIGHTS

This invention was made with government support under CNS 0855106 awarded by the National Science Foundation. The government has certain rights in the invention.

### BACKGROUND

Software testing is an important means for quality assurance of software. It aims at finding bugs by executing a program. Because software testing is labor intensive and expensive, it is highly desirable to automate or partially automate the testing process. To this end, model-based testing (MBT) has recently gained much attention. MBT uses behavior models of a system under test (SUT) for generating and executing test cases. Finite state machines and unified modeling language models are among the most popular modeling formalisms for MBT. However, existing MBT research cannot fully automate test code generation or execution for two reasons. First, tests generated from a model are often incomplete because the actual parameters are not determined. For example, when a test model is represented by a state machine or sequence diagram with constraints (e.g., preconditions and postconditions), it is hard to automatically determine the actual parameters of test sequences so that all constraints along each test sequences are satisfied. Second, tests generated from a model are not immediately executable because modeling and programming use different languages. Automated execution of these tests often requires implementation-specific test drivers or adapters.

Vulnerabilities of software applications are also major source of cyber security risks. Sufficient protection of software applications from a variety of different attacks is beyond the current capabilities of network-level and operating system (OS)-level security mechanisms such as cryptography, firewalls, and intrusion detection, to name a few, because they lack knowledge of application semantics. Security attacks typically result from unintended behaviors or invalid inputs. Security testing is labor intensive because a real-world program usually has too many invalid inputs. Thus, it is also highly desirable to automate or partially automate a security testing process.

### SUMMARY

In an example embodiment, a method of creating test code automatically from a test model is provided. In the method, an indicator of an interaction by a user with a user interface window presented in a display of a computing device is received. The indicator indicates that a test model definition is created. A mapping window includes a first column and a second column. An event identifier is received in the first column and text mapped to the event identifier is received in the second column. The event identifier defines a transition included in the test model definition and the text defines code implementing a function of a system under test associated with the transition in the mapping window. A code window is presented in the display. Helper code text is received. The helper code text defines second code to generate executable code from the code implementing the function of the system under test. Executable test code is generated using the code implementing the function of the system under test and the second code.

In another example embodiment, a computer-readable medium is provided having stored thereon computer-readable instructions that when executed by a computing device, cause the computing device to perform the method of creating test code automatically from a test model.

In yet another example embodiment, a system is provided. The system includes, but is not limited to, a display, a processor and a computer-readable medium operably coupled to the processor. The computer-readable medium has instructions stored thereon that when executed by the processor, cause the system to perform the method of creating test code automatically from a test model.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a block diagram of a test code generation system in accordance with an illustrative embodiment.

FIG. 2 depicts a block diagram of a SUT device of the test code generation system of FIG. 1 in accordance with an illustrative embodiment.

FIG. 3 depicts a block diagram of a testing device of the test code generation system of FIG. 1 in accordance with an illustrative embodiment.

FIG. 4 depicts a flow diagram illustrating example operations performed by a test code generation application executed by the testing device of FIG. 3 in accordance with an illustrative embodiment.

FIGS. 5-23 depict user interface windows created under control of the test code generation application of FIG. 4 in accordance with an example embodiment.

FIGS. 24a-24c depict an algorithm illustrating example operations performed by a test code generation application executed by the testing device of FIG. 3 to develop test code in an object-oriented language in accordance with an illustrative embodiment.

FIGS. 25a-25d depict an algorithm illustrating example operations performed by a test code generation application executed by the testing device of FIG. 3 to generate security tests from a threat net in accordance with an illustrative embodiment.

FIGS. 26a-26b depict an algorithm illustrating example operations performed by a test code generation application executed by the testing device of FIG. 3 to generate test code in HTML/Selenium in accordance with an illustrative embodiment.

FIGS. 27a-27c depict an algorithm illustrating example operations performed by a test code generation application executed by the testing device of FIG. 3 to generate test sequences for reachability coverage with dirty tests in accordance with an illustrative embodiment.

### DETAILED DESCRIPTION

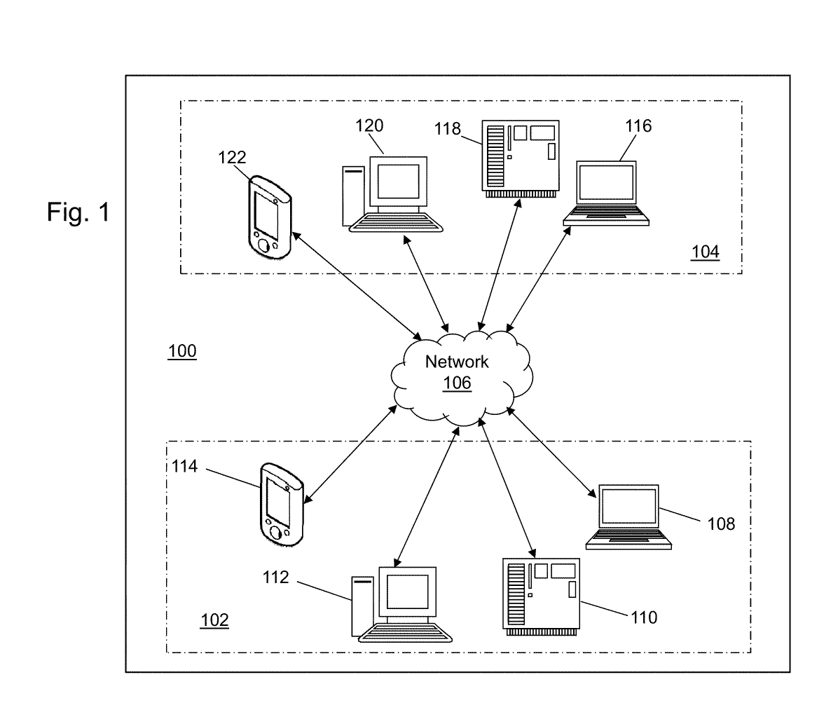

With reference to FIG. 1, a block diagram of a test code generation system 100 is shown in accordance with an illustrative embodiment. In an illustrative embodiment, test code generation system 100 may include a system under test (SUT) 102, a testing system 104, and a network 106. Testing system 104 generates test code that can be executed with little or no additional modification to test SUT 102. Automated test code generation and execution enables more test cycles due to repeatable tests and more frequent test runs. The generated tests also assure the required coverage of test models with little duplication. The automation also facilitates quick and efficient verification of requirement changes and bug fixes and minimizes human errors.

The components of test code generation system 100 may be included in a single computing device, may be positioned in a single room or adjacent rooms, in a single facility, and/or may be remote from one another. Network 106 may include one or more networks of the same or different types. Network 106 can be any type of wired and/or wireless public or private network including a cellular network, a local area network, a wide area network such as the Internet, etc. Network 106 further may be comprised of sub-networks and consist of any number of devices.

SUT 102 may include one or more computing devices. The one or more computing devices of SUT 102 send and receive signals through network 106 to/from another of the one or more computing devices of SUT 102 and/or to/from testing system 104. SUT 102 can include any number and type of computing devices that may be organized into subnets. The one or more computing devices of SUT 102 may include computers of any form factor such as a laptop 108, a server computer 110, a desktop 112, a smart phone 114, an integrated messaging device, a personal digital assistant, a tablet computer, etc. SUT 102 may include additional types of devices. The one or more computing devices of SUT 102 may communicate using various transmission media that may be wired or wireless as known to those skilled in the art. The one or more computing devices of SUT 102 further may communicate information as peers in a peer-to-peer network using network 106.

Testing system 104 may include one or more computing devices. The one or more computing devices of testing system 104 send and receive signals through network 106 to/from another of the one or more computing devices of testing system 104 and/or to/from SUT 102. Testing system 104 can include any number and type of computing devices that may be organized into subnets. The one or more computing devices of testing system 104 may include computers of any form factor such as a laptop 116, a server computer 118, a desktop 120, a smart phone 122, a personal digital assistant, an integrated messaging device, a tablet computer, etc. Testing system 104 may include additional types of devices. The one or more computing devices of testing system 104 may communicate using various transmission media that may be wired or wireless as known to those skilled in the art. The one or more computing devices of testing system 104 further may communicate information as peers in a peer-to-peer network using network 106.

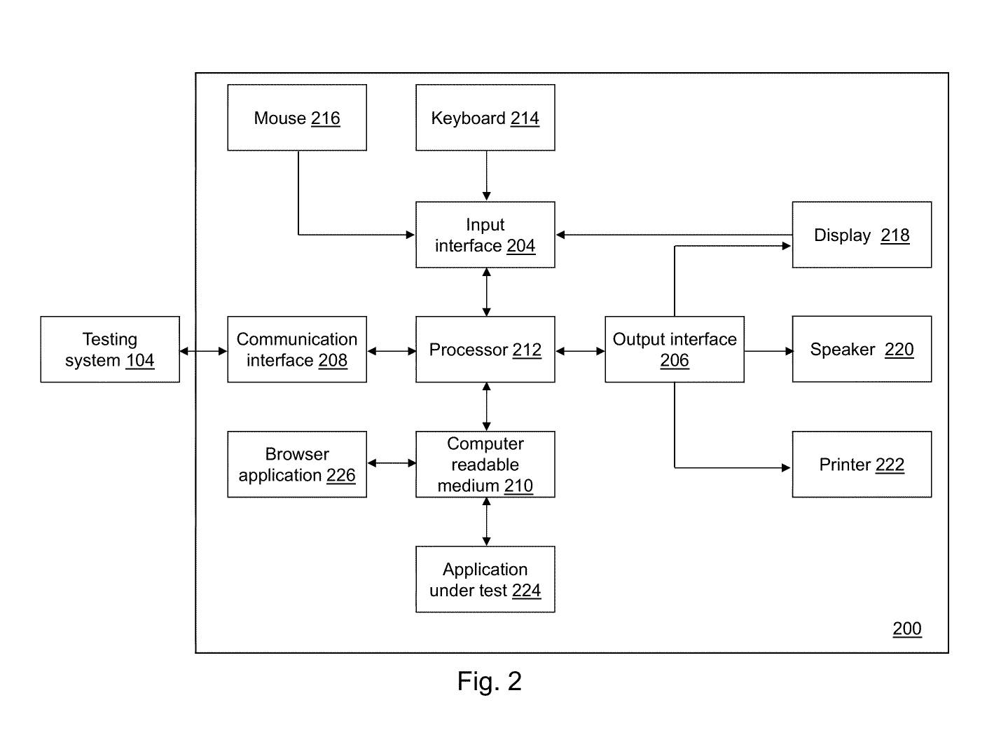

With reference to FIG. 2, a block diagram of a SUT device 200 of SUT 102 is shown in accordance with an illustrative embodiment. SUT device 200 is an example computing device of SUT 102. SUT device 200 may include an input interface 204, an output interface 206, a communication interface 208, a computer-readable medium 210, a processor 212, a keyboard 214, a mouse 216, a display 218, a speaker 220, a printer 212, an application under test (AUT) 224, and a browser application 226. Fewer, different, and additional components may be incorporated into SUT device 200.

Input interface 204 provides an interface for receiving information from the user for entry into SUT device 200 as known to those skilled in the art. Input interface 204 may interface with various input technologies including, but not limited to, keyboard 214, display 218, mouse 216, a track ball, a keypad, one or more buttons, etc. to allow the user to enter information into SUT device 200 or to make selections presented in a user interface displayed on display 218. The same interface may support both input interface 204 and output interface 206. For example, a display comprising a touch screen both allows user input and presents output to the user. SUT device 200 may have one or more input interfaces that use the same or a different input interface technology. Keyboard 214, display 218, mouse 216, etc. further may be accessible by SUT device 200 through communication interface 208.

Output interface 206 provides an interface for outputting information for review by a user of SUT device 200. For example, output interface 206 may interface with various output technologies including, but not limited to, display 218, speaker 220, printer 222, etc. Display 218 may be a thin film transistor display, a light emitting diode display, a liquid crystal display, or any of a variety of different displays known to those skilled in the art. Speaker 220 may be any of a variety of speakers as known to those skilled in the art. Printer 222 may be any of a variety of printers as known to those skilled in the art. SUT device 200 may have one or more output interfaces that use the same or a different interface technology. Display 218, speaker 220, printer 222, etc. further may be accessible by SUT device 200 through communication interface 208.

Communication interface 208 provides an interface for receiving and transmitting data between devices using various protocols, transmission technologies, and media as known to those skilled in the art. Communication interface 208 may support communication using various transmission media that may be wired or wireless. SUT device 200 may have one or more communication interfaces that use the same or a different communication interface technology. Data and messages may be transferred between testing SUT 102 and system 104 using communication interface 208.

Computer-readable medium 210 is an electronic holding place or storage for information so that the information can be accessed by processor 212 as known to those skilled in the art. Computer-readable medium 210 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., CD, DVD, . . . ), smart cards, flash memory devices, etc. SUT device 200 may have one or more computer-readable media that use the same or a different memory media technology. SUT device 200 also may have one or more drives that support the loading of a memory media such as a CD or DVD. Information may be exchanged between testing SUT 102 and system 104 using computer-readable medium 210.

Processor 212 executes instructions as known to those skilled in the art. The instructions may be carried out by a special purpose computer, logic circuits, or hardware circuits. Thus, processor 212 may be implemented in hardware, firmware, or any combination of these methods and/or in combination with software. The term “execution” is the process of running an application or the carrying out of the operation called for by an instruction. The instructions may be written using one or more programming language, scripting language, assembly language, etc. Processor 212 executes an instruction, meaning that it performs/controls the operations called for by that instruction. Processor 212 operably couples with input interface 204, with output interface 206, with computer-readable medium 210, and with communication interface 208 to receive, to send, and to process information. Processor 212 may retrieve a set of instructions from a permanent memory device and copy the instructions in an executable form to a temporary memory device that is generally some form of RAM. SUT device 200 may include a plurality of processors that use the same or a different processing technology.

AUT 224 performs operations associated with any type of software program. The operations may be implemented using hardware, firmware, software, or any combination of these methods. With reference to the example embodiment of FIG. 2, AUT 224 is implemented in software (comprised of computer-readable and/or computer-executable instructions) stored in computer-readable medium 210 and accessible by processor 212 for execution of the instructions that embody the operations of AUT 224. AUT 224 may be written using one or more programming languages, assembly languages, scripting languages, etc.

AUT 224 may be implemented as a Web application. For example, AUT 224 may be configured to receive hypertext transport protocol (HTTP) responses from other computing devices such as those associated with testing system 104 and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol. The file accessed may be a simple text file, an image file, an audio file, a video file, an executable, a common gateway interface application, a Java applet, or any other type of file supported by HTTP. Thus, AUT may be a standalone program or a web based application.

Browser application 226 performs operations associated with retrieving, presenting, and traversing information resources provided by a web application and/or web server as known to those skilled in the art. An information resource is identified by a uniform resource identifier (URI) and may be a web page, image, video, or other piece of content. Hyperlinks in resources enable users to navigate to related resources. Example browser applications 226 include Navigator by Netscape Communications Corporation, Firefox® by Mozilla Corporation, Opera by Opera Software Corporation, Internet Explorer® by Microsoft Corporation, Safari by Apple Inc., Chrome by Google Inc., etc. as known to those skilled in the art. Browser application 226 may integrate with AUT 224.

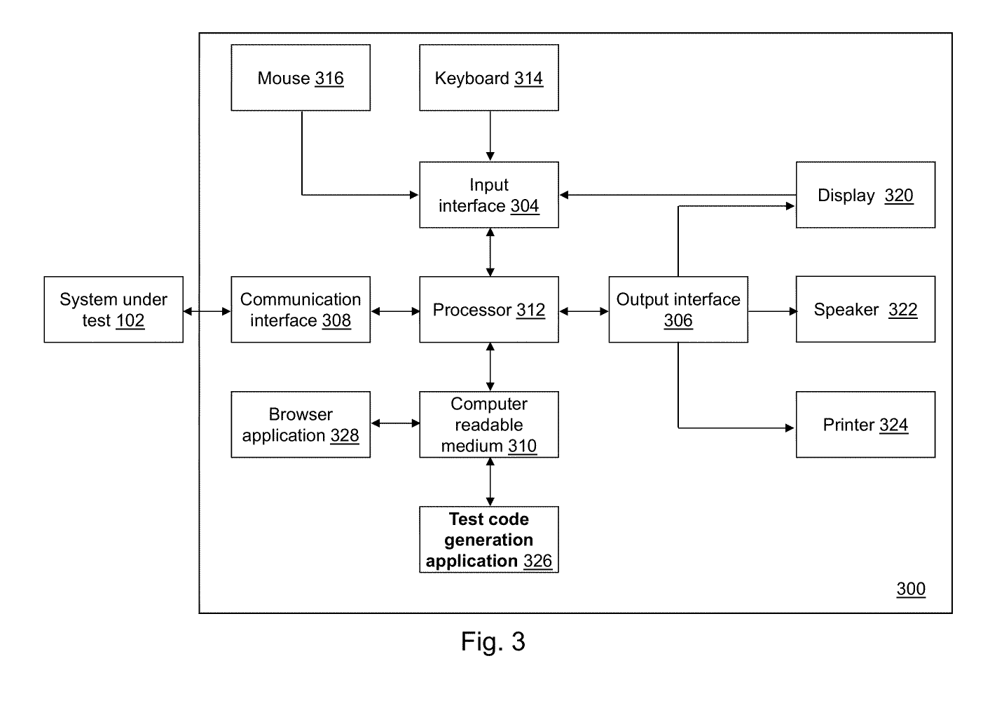

With reference to FIG. 3, a block diagram of a testing device 300 of testing system 104 is shown in accordance with an example embodiment. Testing device 300 is an example computing device of testing system 104. Testing device 300 may include a second input interface 304, a second output interface 306, a second communication interface 308, a second computer-readable medium 310, a second processor 312, a second keyboard 314, a second mouse 316, a second display 320, a second speaker 322, a second printer 324, a test code generation application 326, and a second browser application 328. Fewer, different, and additional components may be incorporated into testing device 300.

Second input interface 304 provides the same or similar functionality as that described with reference to input interface 204 of SUT device 200. Second output interface 306 provides the same or similar functionality as that described with reference to output interface 206 of SUT device 200. Second communication interface 308 provides the same or similar functionality as that described with reference to communication interface 208 of SUT device 200. Second computer-readable medium 310 provides the same or similar functionality as that described with reference to computer-readable medium 210 of SUT device 200. Second processor 312 provides the same or similar functionality as that described with reference to processor 212 of SUT device 200. Second keyboard 314 provides the same or similar functionality as that described with reference to keyboard 214 of SUT device 200. Second mouse 316 provides the same or similar functionality as that described with reference to mouse 216 of SUT device 200. Second display 320 provides the same or similar functionality as that described with reference to display 218 of SUT device 200. Second speaker 322 provides the same or similar functionality as that described with reference to speaker 220 of SUT device 200. Second printer 324 provides the same or similar functionality as that described with reference to printer 222 of SUT device 200.

Test code generation application 326 performs operations associated with generating test code configured to test one or more aspects of AUT 224. Some or all of the operations described herein may be embodied in test code generation application 326. The operations may be implemented using hardware, firmware, software, or any combination of these methods. With reference to the example embodiment of FIG. 3, test code generation application 326 is implemented in software (comprised of computer-readable and/or computer-executable instructions) stored in second computer-readable medium 310 and accessible by second processor 312 for execution of the instructions that embody the operations of test code generation application 326. Test code generation application 326 may be written using one or more programming languages, assembly languages, scripting languages, etc. In an illustrative embodiment, test code generation application 326 is written in Java, a platform-independent language.

Second browser application 328 provides the same or similar functionality as that described with reference to browser application 226. Second browser application 328 may integrate with test code generation application 326 for testing of AUT 224.

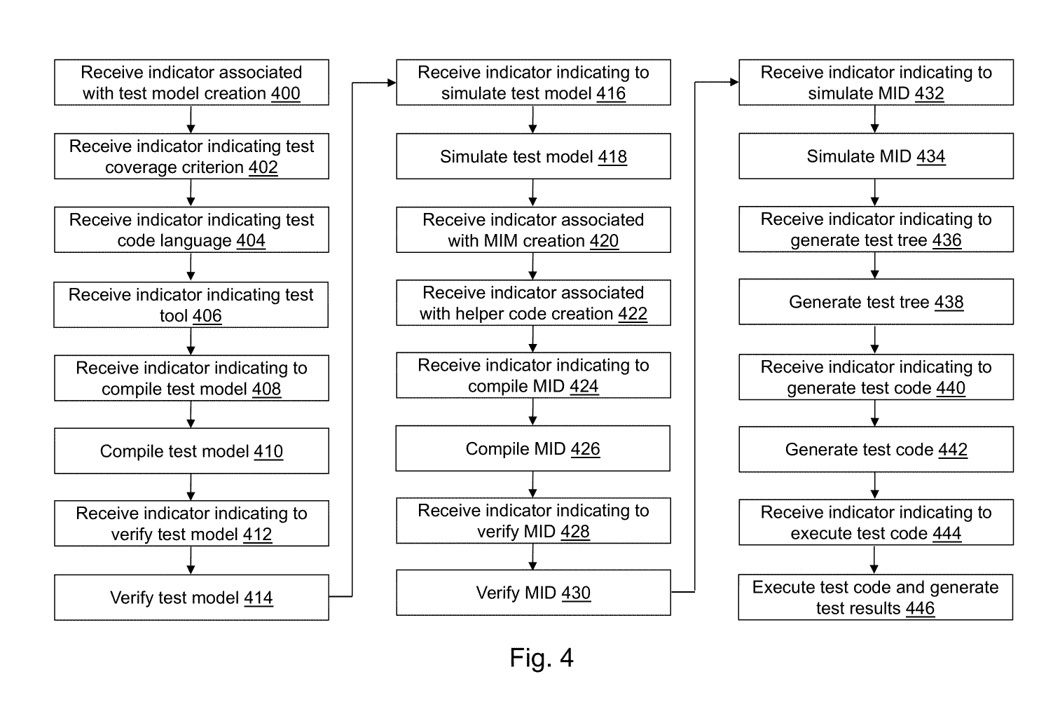

With reference to FIG. 4, example operations associated with test code generation application 326 are described. Additional, fewer, or different operations may be performed depending on the embodiment. For example, test code generation application 326 may provide additional functionality beyond the capability to generate test code. As an example, test code generation application 326 may provide test code compilation, verification, and execution. Thus, in addition to test code generation for offline test execution, test code generation application 326 may also support on-the-fly testing (simultaneous generation and execution of tests) and online execution of generated tests, for example, through a Selenium web driver or a remote procedure call (RPC) protocol such as extended markup language (XML)-RPC or JavaScript object notation (JSON)-RPC. On-the-fly testing may be particularly useful for non-deterministic systems. Test code generation application 326 can be extended in a straightforward manner based on the description herein to support a new language or a new test engine or test tool.

The order of presentation of the operations of FIG. 4 is not intended to be limiting. A user can interact with one or more user interface windows presented to the user in second display 320 under control of test code generation application 326 independently or through use of browser application 226 and/or second browser application 328 in an order selectable by the user. Thus, although some of the operational flows are presented in sequence, the various operations may be performed in various repetitions, concurrently, and/or in other orders than those that are illustrated. For example, a user may execute test code generation application 326, which causes presentation of a first user interface window, which may include a plurality of menus and selectors such as drop down menus, buttons, text boxes, hyperlinks, pop-up windows, additional windows, etc. associated with test code generation application 326 as understood by a person of skill in the art.

Before executing test code generation application 326, a user determines the properties of AUT 224 to be tested along with a test coverage criterion. Based on this, the user may extract commands and controls from AUT 224 for examination by test code generation application 326. The general workflow for test code generation is to create, edit, save, and modify a model implementation description (MID), which may include a test model for AUT 224, a model implementation mapping (MIM) between the test model and AUT 224, and helper code. The created MID may be compiled, verified, and/or simulated to see if there are any syntactic errors, semantic issues and/or logic issues. A test tree and/or test code is generated from the MID based on a coverage criterion selected by the user. The generated test code may be compiled and executed against the AUT 224. As with any software development process, operations may need to be repeated to develop test code that covers the test space and compiles and executes as determined by the user.

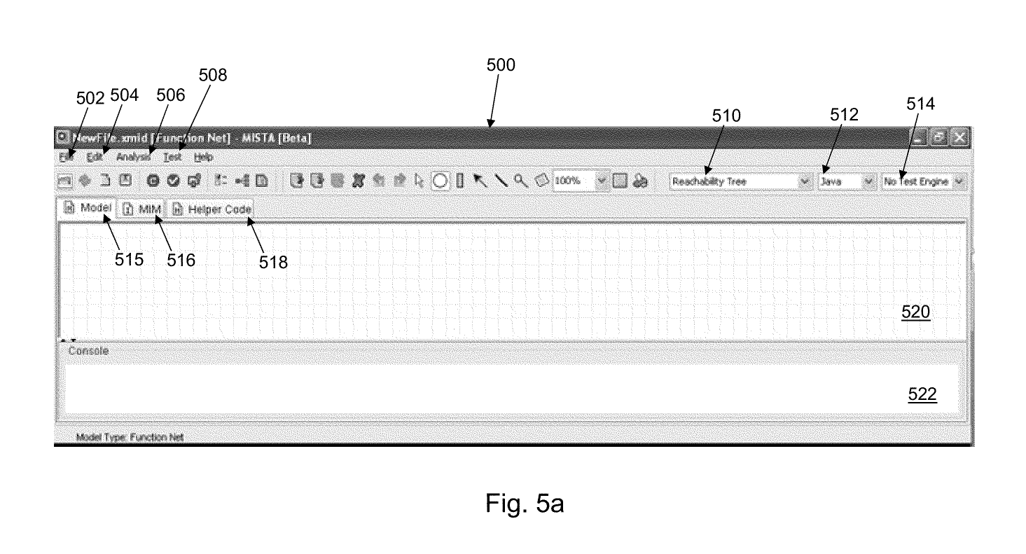

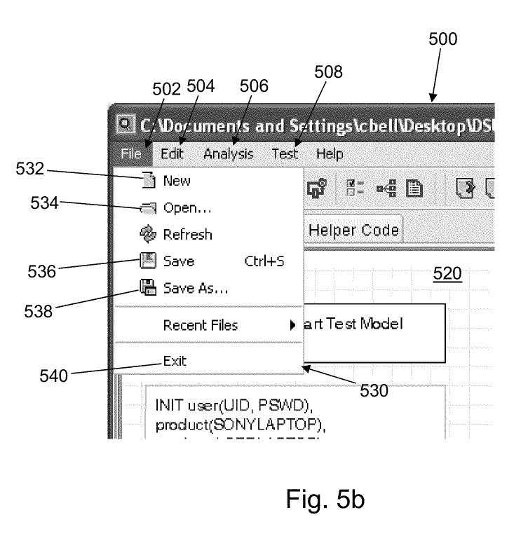

Test code generation application 326 supports creation, management, and analysis of a test model together with the test code. With continuing reference to FIG. 4, in an operation 400 an indicator is received by test code generation application 326, which is associated with creation of a test model. With reference to FIG. 5a, a first user interface window 500 is presented on second display 320 under control of the computer-readable and/or computer-executable instructions of test code generation application 326 executed by second processor 312 of testing device 300 in accordance with an illustrative embodiment after the user accesses/executes test code generation application 326. Of course, other intermediate user interface windows may be presented before first user interface window 500 is presented to the user.

As the user interacts with first user interface 500, different user interface windows may be presented to provide the user with more or less detailed information related to generation of a test model, generation of the MIM, generation of test code, execution of test code, etc. As understood by a person of skill in the art, test code generation application 326 receives an indicator associated with an interaction by the user with a user interface window presented under control of test code generation application 326. Based on the received indicator, test code generation application 326 performs one or more operations that may involve changing all or a portion of first user interface 500.

In the illustrative embodiment, first user interface window 500 includes a file menu 502, an edit menu 504, an analysis menu 506, a test menu 508, a test coverage criterion selector 510, a test language selector 512, a test tool selector 514, a model tab 515, a model implementation mapping (MIM) tab 516, and a helper code tab 518. Model tab 515 may include a test model window 520 and a console window 522. File menu 502, edit menu 504, analysis menu 506, and test menu 508 are menus that organize the functionality supported by test code generation application 326 into logical headings as understood by a person of skill in the art. Additional, fewer, or different menus/selectors/windows may be provided to allow the user to interact with test code generation application 326. Additionally, as understood by a person of skill in the art, a menu and/or a menu item may be selectable by the user using mouse 316, keyboard 314, “hot keys”, display 320, etc.

With reference to FIG. 5b, selection of file menu 502 may trigger creation of a file window 530. File window 530 may include a new selector 532, an open selector 534, a save selector 536, a save as selector 538, and an exit selector 540. Receipt of an indicator indicating user selection of new selector 532 triggers creation of a new model implementation description (MID) file, and test code generation application 326 presents an editor with an empty test model window 520. For a particular model type, there may be multiple editors available. For example, both graphical and spreadsheet editors may be provided for creating and editing the test model. When a new MID file is created, a default editor may be used.

Receipt of an indicator indicating user selection of open selector 534 triggers creation of a window from which the user can browse to and select a previously created MID file for opening by test code generation application 326. The selected MID file is opened and the associated information is presented in first user interface window 500. For example, the test model may be presented in test model window 520 for further editing or review by the user. Receipt of an indicator indicating user selection of save selector 536 triggers saving of the information associated with the MID currently being edited using first user interface window 500. Receipt of an indicator indicating user selection of save as selector 538 triggers saving of the information associated with the MID currently being edited using a new MID file filename. Receipt of an indicator indicating user selection of exit selector 540 triggers closing of test code generation application 326.

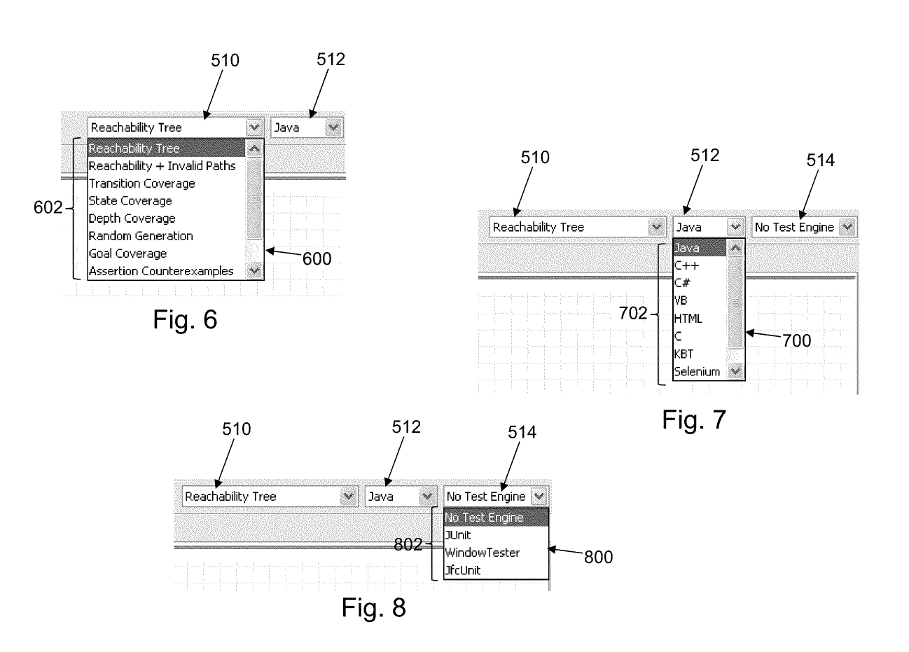

With reference to FIG. 6, selection of test coverage criterion selector 510 may trigger creation of a criterion drop-down window 600. Criterion drop-down window 600 may include a plurality of criterion selectors 602 from which the user may select a coverage criterion for the test model. Test code generation application 326 supports various testing activities, including, but not limited to, function testing, acceptance testing and graphical user interface (GUI) testing, security testing, programmer testing, regression testing, etc. Thus, test code generation application 326 can be used to generate function tests for exercising interactions among the components of SUT device 200. Test code generation application 326 also can be used to generate various sequences of use scenarios and GUI actions. Test code generation application 326 can be used to test whether or not SUT device 200 is subject to security attacks by using threat models and whether or not SUT device 200 has enforced security policies by using access control models. Test code generation application 326 can be used to test interactions within individual classes or groups of classes. Test code generation application 326 can also be used in test-driven development, where test code is created before the product code is written. Test code generation application 326 can also be used after changes to SUT device 200 including changes to AUT 224. Test code generation application 326 generates test cases to meet the coverage criterion chosen from the plurality of criterion selectors 602.

The plurality of criterion selectors 602 may include reachability tree coverage (all paths in reachability graph), reachability coverage plus invalid paths (negative tests), transition coverage, state coverage, depth coverage, random generation, goal coverage, assertion counter examples, deadlock/termination state coverage, generation from given sequences, etc. For reachability tree coverage, test code generation application 326 generates a reachability graph of a function net with respect to all given initial states and, for each leaf node, creates a test from the corresponding initial state node to the leaf.

For reachability coverage plus invalid paths (sneak paths), test code generation application 326 generates an extended reachability graph. Thus, for each node, test code generation application 326 also creates child nodes that include invalid firings as leaf nodes. A test from the corresponding initial marking to such a leaf node may be termed a dirty test.

For transition coverage, test code generation application 326 generates tests to cover each transition. For state coverage, test code generation application 326 generates tests to cover each state that is reachable from any given initial state. The test suite is usually smaller than that of reachability tree coverage because duplicate states are avoided. For depth coverage, test code generation application 326 generates all tests whose lengths are no greater than the given depth.

For random generation, test code generation application 326 generates tests in a random fashion. The parameters used as the termination condition are the maximum depth of tests and the maximum number of tests. When this menu item is selected, test code generation application 326 requests that the user define the maximum number of tests to be generated. The actual number of tests is not necessarily equal to the maximum number because random tests can be duplicated.

For goal coverage, test code generation application 326 generates a test for each given goal that is reachable from the given initial states. For assertion counterexamples, test code generation application 326 generates tests from the counterexamples of assertions that result from assertion verification. For deadlock/termination states, test code generation application 326 generates tests that reach each deadlock/termination state in the function net. A deadlock/termination state is a marking under which no transition can be fired. For generation from given sequences, test code generation application 326 generates tests from firing sequences defined and stored in a sequence file, which may be a log file of a simulation or of online testing.

With reference to FIG. 7, selection of test language selector 512 may trigger creation of a test language drop-down window 700. Test language drop-down window 700 may include a plurality of test language selectors 702 from which the user may select a test language for the test code generated by test code generation application 326. Test code generation application 326 may support generation of executable test code or test scripts in various languages including Java, C#, C++, Visual Basic (VB), C, HTML, Selenium, RPC, KBT, etc.

With reference to FIG. 8, selection of test tool selector 514 may trigger creation of a test tool drop-down window 800. Test tool drop-down window 800 may include a plurality of test tool selectors 802 from which the user may select a test tool for the test code generation. The plurality of test tool selectors 802 may vary based on the test language selected by the user using test language selector 512 because the test framework varies based on the language selected. For example, the plurality of test tool selectors 802 may include “No Test Engine”, JUnit, WindowTester, or JfcUnit if Java is the selected test language. The plurality of test tool selectors 802 may include “No Test Engine” and NUnit if C# is the selected test language. The C++, VB, and C test languages may not include a test tool selection. HTML may automatically use the Selenium integrated data environment (IDE), and KBT may automatically use the Robot Framework. Test code generation application 326 generates executable test code based on the selected test language and/or test tool. The generated test code can be executed against AUT 224.

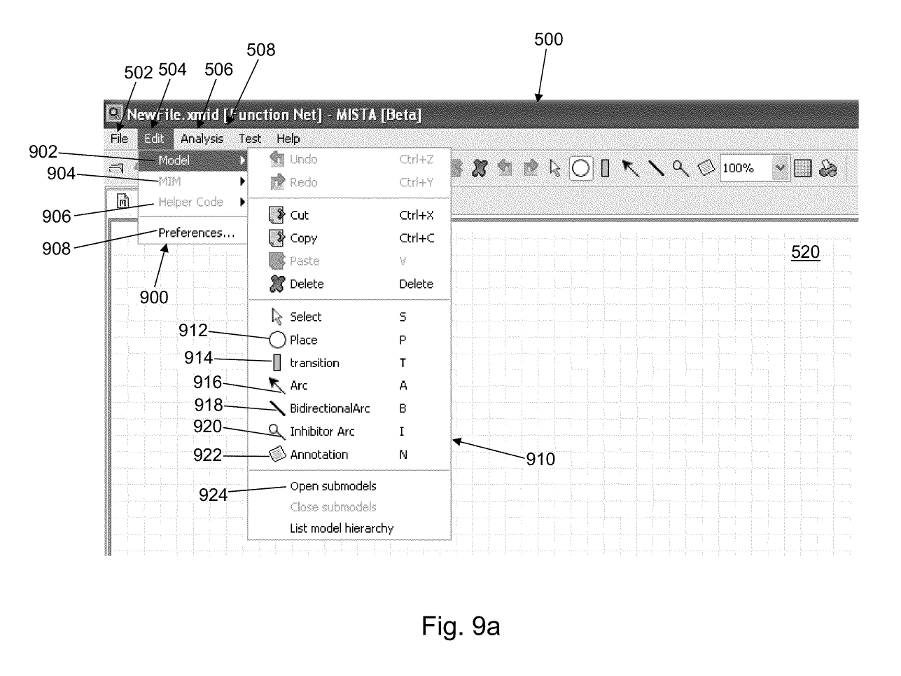

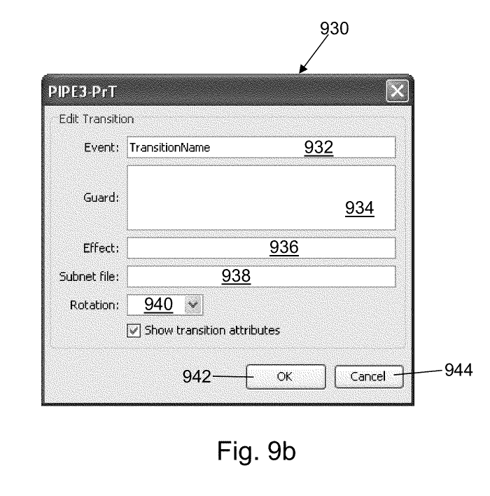

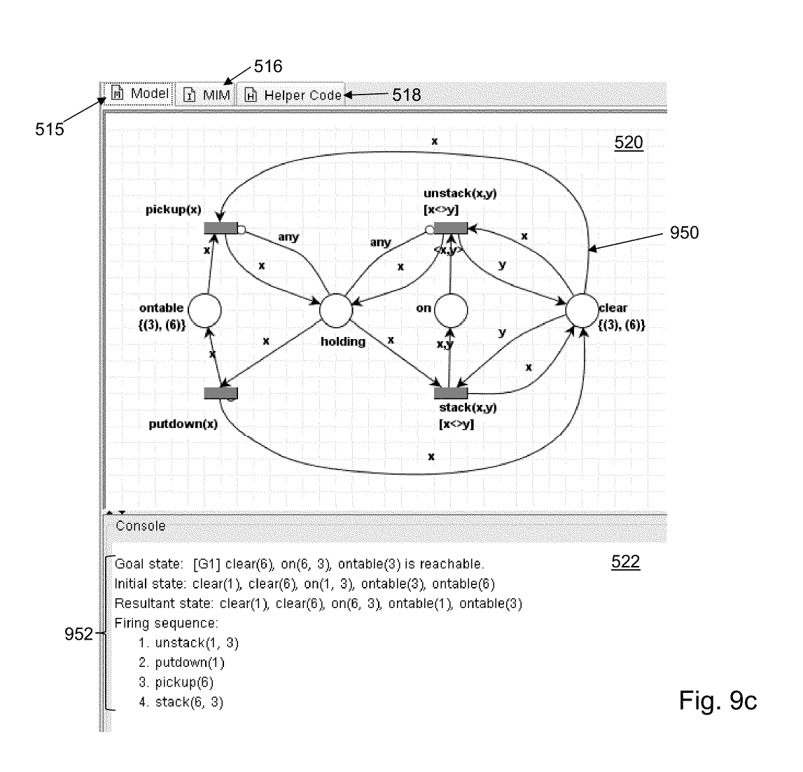

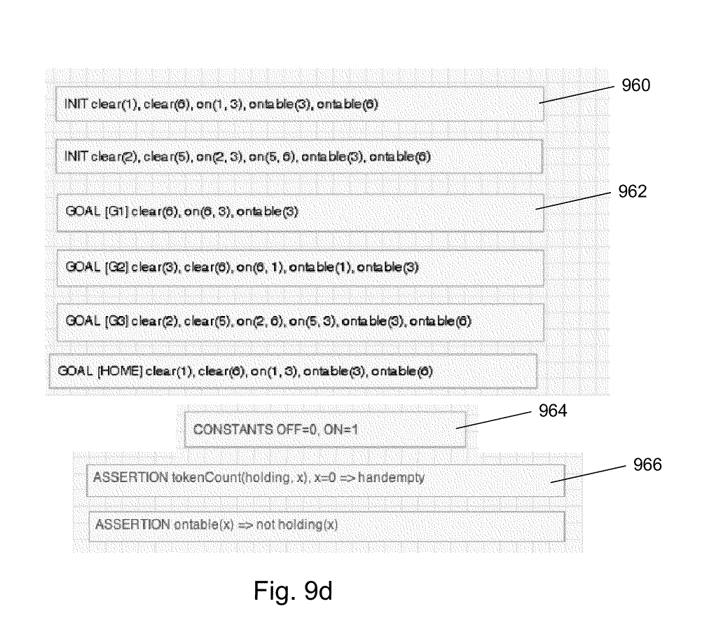

With reference to FIG. 9a, selection of edit menu 504 may trigger creation of an edit window 900. Edit window 900 may include a model selector 902, a MIM selector 904, a helper code selector 906, and a preferences selector 908. Receipt of an indicator indicating user selection of preferences selector 908 triggers opening of a window in which the user can select preferences associated with use of test code generation application 326. For example, the user may be able to select the text fonts used, the type of test model editor as between graphical and textual (i.e., spreadsheet format), etc.

Model selector 902, MIM selector 904, helper code selector 906 are linked to model tab 515, MIM tab 516, and helper code tab 518, respectively. Only one of model selector 902, MIM selector 904, and helper code selector 906 may be enabled based on the currently selected tab as between model tab 515, MIM tab 516, and helper code tab 518. Because in the illustrative embodiment of FIG. 9a, model tab 515 is selected, only model selector 902 is enabled. MIM selector 904 and helper code selector 906 are not enabled as indicated by the use of grayed text.

Receipt of an indicator indicating user selection of model selector 902 triggers creation of a model edit tool window 910. Model edit tool window 910 includes editing tools for creating or modifying a test model presented in test model window 520. In an illustrative embodiment, test code generation application 326 may support the creation of test models as function nets, which are a simplified version of high-level Petri nets such as colored Petri nets or predicate/transition (PrT) nets, as a finite state machine such as a unified modeling language (UML) protocol state machine, or as contracts with preconditions and postconditions. Function nets as test models can represent both control- and data-oriented test requirements and can be built at different levels of abstraction and independent of the implementation. For example, entities in a test model are not necessarily identical to those in AUT 224.

Function nets provide a unified representation of test models. As a result, test code generation application 326 automatically transforms the given contracts or finite state machine test model into a function net. Function nets are a super set of finite state machines. A function net reduces to a finite state machine if (1) each transition has at most one input place and at most one output place, (2) all arcs use the default arc label, and (3) each initial marking has one token at only one place. To represent a finite state machine by a function net, suppose (sᵢ, e [p, q], sⱼ) is a transition in a finite state machine, where sᵢ is the source state, e is the event, sᵢ is the destination state, p is the guard condition, and q is the postcondition. For each of such transitions, a source place sᵢ, a destination place and a transition with event e with guard condition p and effect q can be created. If sᵢ=sⱼ, sᵢ is both the input and output place and there is a bi-directional arc between sᵢ and the transition.

The user creates and edits a test model in test model window 520 of model tab 515 using tool selectors included in model edit tool window 910. When the test model is edited with a graphical editor, a separate XML file may be created to store information associated with creating the graphical representation of the test model. For example, an XML file based on the Petri net markup language defined by the standard ISO/IEC 15909 Part 2 may be used.

In an illustrative embodiment, model edit tool window 910 includes an add place selector 912, an add transition selector 914, an add directed arc selector 916, an add bidirectional arc selector 918, an add inhibitor arc selector 920, an add annotation selector 922, and an open submodels selector 924 among other common editing tools such as a cut selector, a paste selector, a delete selector, a select selector, etc. as understood by a person of skill in the art. The user creates the test model as a function net that consists of places (represented by circles), transitions (represented by rectangles), labeled arcs connecting places and transitions, and initial states.

A place represents a condition or state and is added to the test model using add place selector 912. A transition represents an operation or function (e.g., component call) and is added to the test model using add transition selector 914. After adding a transition to the test model being created in test model window 520, characteristics of the added transition can be edited. For example, with reference to FIG. 9b, an edit transition window 930 is shown in accordance with an illustrative embodiment. Edit transition window 930 includes an event textbox 932, a guard textbox 934, an effect textbox 936, a subnet file textbox 938, a rotation selector 940, an Ok button 942, and a cancel button 944. The user enters a name and an optional list of variables for the transition in event textbox 932. The user enters guard and effect conditions, which are optional conditions, into guard textbox 934 and effect textbox 936. A condition is a list of predicates separated by “,”, which means logical “and”. A predicate is of the form [not] p (x₁, x₂, . . . , xₙ), where “not” (negation) is optional. The built-in predicates for specifying guard conditions include=, < >(!=), >, >=, <, <=, +, −, *, /, %, etc.

A hierarchy of function nets can be built by linking a transition to another function net called a subnet. Thus, the test model may include sub models, which can be viewed by selecting open submodels selector 924. A subnet can be linked to the transition by entering the subnet file in subnet file textbox 938. For example, the subnet file may be an XML file. Test code generation application 326 composes a net hierarchy into one net by substituting each transition for its subnet as defined in the subnet file defined in subnet file textbox 938.

Rotation selector 940 allows the user to change the angle of orientation of the transition box used to represent the transition in test model window 520. Selection of OK button 942 closes edit transition window 930 and saves the entered data to the test mode file. Selection of cancel button 944 closes edit transition window 930 without saving the entered data to the test model file.

With continuing reference to FIG. 9a, an arc label represents parameters associated with transitions and places. There may be three types of arcs. A directed arc is from a place to a transition (representing a transition's input or precondition) or from a transition to a place (representing a transition's output or postcondition) and is added to the test model using add directed arc selector 916. A special output arc labeled by “RESET” may be called a reset arc. All the data in the output place connected by the reset arc is cleared when the transition is fired. A no-directed (or bi-directional) arc between a place and a transition (representing both input/output or pre-/post-condition of the transition) can be added to the test model using add bidirectional arc selector 918. If a place is both input and output of a transition, but the transition changes the input value, two directed arcs with different variables in the arc labels may be used. An inhibitor arc from a place to a transition represents a negative precondition of the transition and can be added to the test model using add inhibitor arc selector 920.

To add an arc to a test model, the arc type is selected from add directed arc selector 916, add bidirectional arc selector 918, or add inhibitor arc selector 920 using model edit tool window 910 (or hot-keys, buttons, etc.). The source place or transition is selected in test model window 520, and the pointer is dragged towards the destination transition or place and released at the destination as understood by a person of skill in the art. An inhibitor arc can be drawn from a place to a transition, but not from a transition to a place. Constants can be used in arc labels.

An initial state represents a set of test data and system settings. It is a distribution of data items (called tokens) in places. A data item is of the form p (x₁, x₂, . . . , xₙ), where (x₁, x₂, . . . , xₙ) is a token in place p. “( )” is a non-argument token. There may be two ways to specify an initial state. One is to specify tokens in each place. The other is to use an annotation, which starts with the keyword “INIT”, followed by a list of data items (multiple items may be separated by “,”). An annotation can be added to the test model using add annotation selector 922. There may be other types of annotations that can be added to the test model using add annotation selector 922 as discussed later herein.

A place (circle) represents a condition or state. It is named by an identifier, starting with a letter and consists of letters, digits, dots, and underscores. Places can hold data called tokens. Each token in a place is of the form (X₁, X₂, . . . , Xₙ), where (X₁, X₂, . . . , Xₙ) are constants. A constant can be an integer (e.g., 3, −2), a named integer (e.g., ON) defined through a CONSTANTS annotation, a string (e.g., “hello” and “−10”), or a symbol starting with an uppercase letter (e.g., “Hello” and “2hot”). “( )” is a non-argument token similar to a token in a place/transition net. Multiple tokens in the same place are separated by “,”. They should be different from each other but have the same number of arguments. A distribution of tokens in all places of a function net is called a marking of the net. In particular, if any tokens are specified in the working net, the tokens collected from all places of the net may be viewed as an initial marking. Initial markings can also be specified in annotations. Therefore, multiple initial markings can be specified for the same function net.

With reference to FIG. 9c, the structure of a function net 950 is shown in accordance with an illustrative embodiment in test model window 520. A graphical representation is used where function net 950 is represented by a set of transitions, where each transition is a quadruple <event,precondition,postcondition,guard>. The precondition, postcondition, and guard are first-order logic formulas. The precondition and postcondition correspond to the input and output places of the transition, respectively. This forms the basis of a textual description of a function net. A transition (rectangle) represents an event or function. The event signature of a transition includes the event name and an optional list of variables, entered in event textbox 932, as its formal parameters. A variable is an identifier that starts with a lowercase letter or “?”. Each variable is defined in an arc label that is connected to the transition or in the guard condition of the transition. If the list of formal parameters is not provided, all variables collected from the arcs connected to the transition become the formal parameters. The variables are listed according to the order in which the arcs are drawn. If the specified list is ( ) there is no formal parameter no matter how many variables appear in the input arcs.

The guard condition of a transition can be built from arithmetic or relational predicates, where variables are defined in the labels of arcs connected to the transition or arithmetic operations in the guard condition. Arithmetic operators (+, −, *, /, %) in a guard condition can introduce new variables. For example, z=x+y defines z using x and y if z has not occurred before. After this, z can be used in another predicate, such as z>5 or t=z+1. If z has been defined before z=x+y is defined, z=x+y refers to a comparison of z with x+y. The built-in predicates for specifying guard conditions may include equal, not equal, greater than, greater than or equal, less than, less than or equal, addition, subtraction, multiplication, division, modulo, odd/even, belongs to belongs to the set, bound, assert, and token count. The predicates may include variables, integers, named integers, or integer strings. The effect of a transition provides a way to define test oracles. Each predicate in the effect can be mapped to a test oracle when tests are generated from a function net.

As discussed previously, an arc represents a relationship between a place and a transition. An arc can be labeled by one or more lists of arguments. Each argument is a variable or constant. Each list contains zero or more arguments. For an unlabeled arc, the default arc label is < >, which contains no argument. This arc is similar to the arcs in a place/transition net with one as the weight. In an illustrative embodiment, the labels of all arcs connected to and from the same place have the same number of arguments, although the variables can be different. This is because all tokens in the same place have the same number of arguments. Thus, multiple lists of labels on the same arc, separated by “&”, have the same number of arguments. Variables of the same name may appear in different transitions and arc labels. The scope of a variable in an arc is determined by the associated transition. Variables of the same name may refer to the same variable only when they are associated with the same transition.

Function net 950 represents a single-handed robot or software agent that tries to reach the given goal state of stacks of blocks on a large table from the initial state by using four operators: pickup, putdown, stack, and unstack. These operators are software components (e.g., methods in Java) in a repository style of architecture. They are called by a human or software agent to play the blocks game. The applicability of the components depends on the current arrangement of blocks as well as the agent's state. For example, “pick up block x” is applicable only when block x is on table, it is clear (i.e., there is no other block on it), and the agent is holding no block. Once this operation is completed, the agent holds block x, and block x is not on table, and is not clear. These conditions form a contract between the component “pick up block x” and its agents.

With reference to FIG. 9d, an annotation can include an initial state, a goal state, a constant, an assertion, comments, and so on. For example, an initial state annotation 960 starts with the keyword “INIT” followed by an optional name and a list of tokens separated by “,”. Since an initial state specifies a concrete state, no variables or predicates should be used.

Similarly, a goal annotation 962 starts with the keyword “GOAL” and specifies a goal state or a desirable marking. Goal states can be used for reachability analysis of the test model or for generating tests to exercise specific states. A goal property can be a concrete marking, which consists of specific tokens. The goal names can be used to generate tag code that indicates the points in test cases where the given goal markings have passed. In goal properties, variables, negation, and predicates (similar to those in guard conditions of transitions) can be used to describe certain markings of interest. The multiple occurrences of the same variable in the same goal specification may refer to the same object.

As another example, a constant annotation 964 starts with the keyword “CONSTANTS” and defines a list of named integers separated by “,”, such as OFF=0, ON=1. The named constants can be used in tokens, arc labels, guard conditions, initial markings, and goal markings. In particular, they can be used in arithmetic predicates of guard conditions. The resultant value is translated into a named constant if possible. For example, if x₁=OFF(0), then x₂=ON−x₁ is 1 and the result is translated into ON.

As another example, a global annotation starts with the keyword “GLOBAL” followed by a list of predicates. Multiple predicates are separated by “,”. Each predicate is of the form p (x₁, x₂, . . . , xₙ), which means that there is a bi-directional arc between place p and each transition, and the arc is labeled by (x₁, x₂, . . . , xₙ). The purpose of global annotations is to make test models more readable when there are global places.

Similar to constant annotation 964, an ENUMERATION annotation defines a list of non-negative integers starting from 0. For example, “ENUMERATION OFF, ON” is the same as “CONSTANTS OFF=0, ON=1”. A sequence annotation starts with the keyword “SEQUENCE” followed by the name of a text file, which contains a sequence of events used for test code generation purposes, for example, when “generation from given sequences” is selected using test coverage criterion selector 510.

As another example, an assertion annotation 966 starts with the keyword “ASSERTION”. Assertions typically represent the properties that are required of the function net. Annotations may also be used to provide textual descriptions about the function net. If an annotation does not contain a keyword (e.g., INIT, GOAL, GLOBAL), the text may be treated as a comment.

With continuing reference to FIG. 4, in operation 400, any of the above described interactions associated with new selector 532, open selector 534, save selector 536, save as selector 538, and model edit tool window 910 may result in an indicator associated with test model creation. In an operation 402, an indicator is received that indicates a selected test coverage criterion. For example, the indicator is received in response to a selection from the plurality of criterion selectors 602 of test coverage criterion selector 510. In an operation 404, an indicator is received that indicates a selected test code language. For example, the indicator is received in response to a selection from the plurality of test language selectors 702 of test language selector 512. In an operation 406, an indicator is received that indicates a selected test tool. For example, the indicator is received in response to a selection from the plurality of test tool selectors 802 of test tool selector 514.

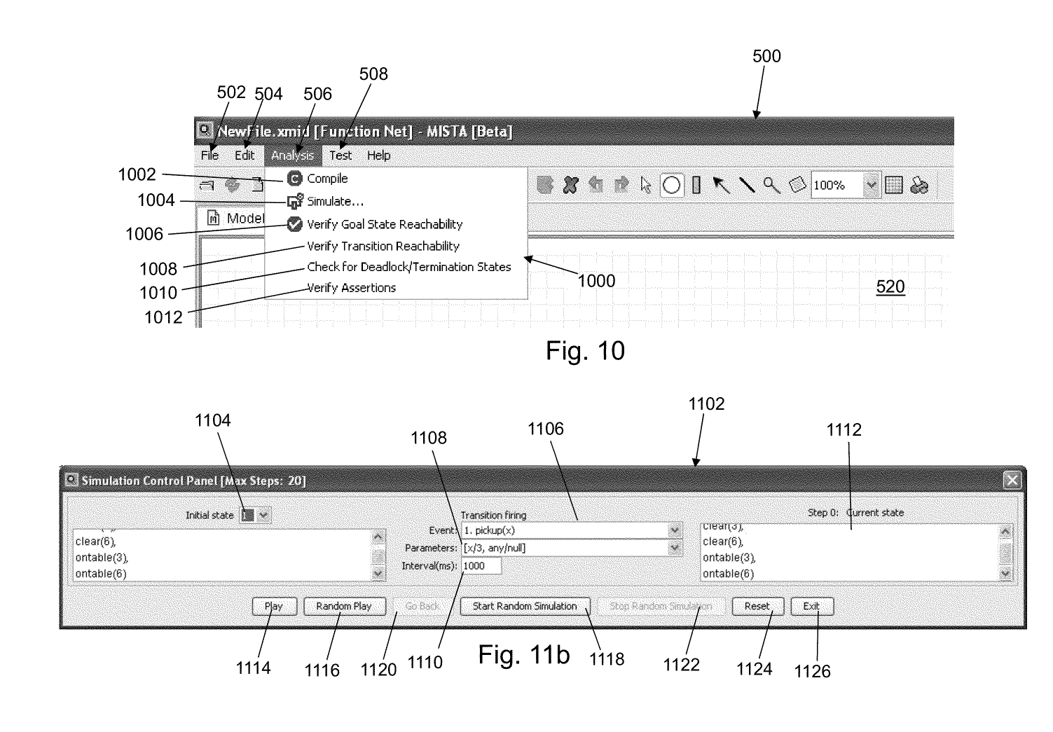

In an operation 408, an indicator is received that indicates that a compilation of the test model is requested by the user. For example, with reference to FIG. 10, selection of analysis menu 506 may trigger creation of an analysis window 1000. Analysis window 1000 may include a compile selector 1002, a simulate selector 1004, a verify goal state reachability selector 1006, a verify transition reachability selector 1008, a check for deadlock/termination states selector 1010, and a verify assertions selector 1012. Receipt of an indicator indicating user selection of compile selector 1002 triggers compilation of the test model presented in test model window 520. Compiling the test model parses the test model and reports syntactic errors in console window 522.

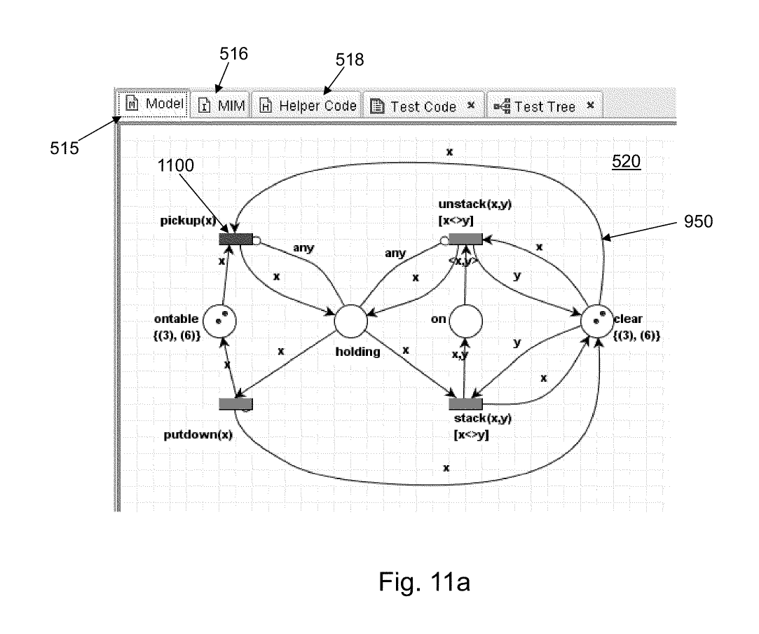

Receipt of an indicator indicating user selection of simulate selector 1004 triggers simulation of the test model presented in test model window 520. Simulating the test model starts stepwise execution of the test model in test model window 520. For example with reference to FIG. 11a, a pickup transition 1100 is indicated as currently enabled or executing in the simulation of function test 950 by highlighting or the color red. Blue dots in places may represent tokens and numbers in places may represent token counts.

With reference to FIG. 11b, a simulate control panel window 1102 is shown in accordance with an illustrative embodiment. Test model simulation demonstrates which transitions are applicable at each state from a given initial state and is useful for debugging test models. Simulate control panel window 1102 may include an initial state selector 1104, an event firing selector 1106, a parameter selector 1108, an interval selector 1110, a current state indicator 1112, a play button 1114, a random play button 1116, a start button 1118, a go back button 1120, a stop button 1122, a reset button 1124, and an exit button 1126. Use of initial state selector 1104 allows the user to select which initial state is used for simulation in case multiple initial states are specified. Use of event firing selector 1106 allows the user to select a transition (event) that can be fired at a current marking. Firing an enabled transition removes the matched token from each input place and adds a token to each output place according to their arc labels and variable values. Therefore, it leads to a new marking. Use of parameter selector 1108 allows the user to select the actual parameters for the firing. Use of interval selector 1110 allows the user to select the time interval between two consecutive firings. By default, it is set at 1 second. Current state indicator 1112 presents the current marking after the transition firing.

Play button 1114 triggers firing of a transition selected by the user. Random play button 1116 triggers firing of a transition randomly selected from a given list of firable events and parameters. Use of go back button 1120 allows the user to go back one step at a time. Start button 1118 is similar to random play button 1116, but once it is selected by the user, the simulation continues until stop button 1122 is selected by the user or no transition is enabled at the current state. If start button 1118 is selected again, the simulation starts again where it left off. Use of reset button 1124 resets the simulation to the selected initial state. Use of exit button 1126 terminates the simulation.

Receipt of an indicator indicating user selection of verify goal state reachability selector 1006 triggers a verification that the given goals are reachable from any initial state in the test model in test model window 520. Receipt of an indicator indicating user selection of verify transition reachability selector 1008 triggers a verification that all transitions are reachable. Typically, all transitions in a test model are reachable unless the test model contains errors. Receipt of an indicator indicating user selection of check for deadlock/termination states selector 1010 triggers a verification to determine if there are any deadlock/termination states, and if so, what sequences of transition firings reach these states. A deadlock/termination state refers to a state under which no transition is firable. It does not necessarily mean the occurrence of deadlock. It can be a normal termination state. Receipt of an indicator indicating user selection of assertions selector 1012 triggers a verification of the specified assertions against the function net. If an assertion is not satisfied, the verification reports a counterexample. Reporting information may be presented in console window 522. For example, with reference to FIG. 9c, console window 522 includes a verification report 952 created after use selection of verify goal state reachability selector 1006.

With continuing reference to FIG. 4, in operation 408, the indicator is received that indicates that a compilation of the test model is requested by the user using, for example, compile selector 1002. In an operation 410, the test model currently enabled and presented in test model window 520 is compiled.

In an operation 412, an indicator is received that indicates that a verification of the test model is requested by the user. For example, an indicator indicating selection of any of verify goal state reachability selector 1006, verify transition reachability selector 1008, check for deadlock/termination states selector 1010, and verify assertions selector 1012 may trigger creation of such an indicator. In an operation 414, the selected verification of the test model is performed by test code generation application 326.

In an operation 416, an indicator is received that indicates that a simulation of the test model is requested by the user. For example, an indicator indicating selection of simulate selector 1004 may trigger creation of such an indicator. In an operation 418, the simulation of the test model is performed by test code generation application 326 under control of the user interacting with the controls presented in simulate control panel window 1102.

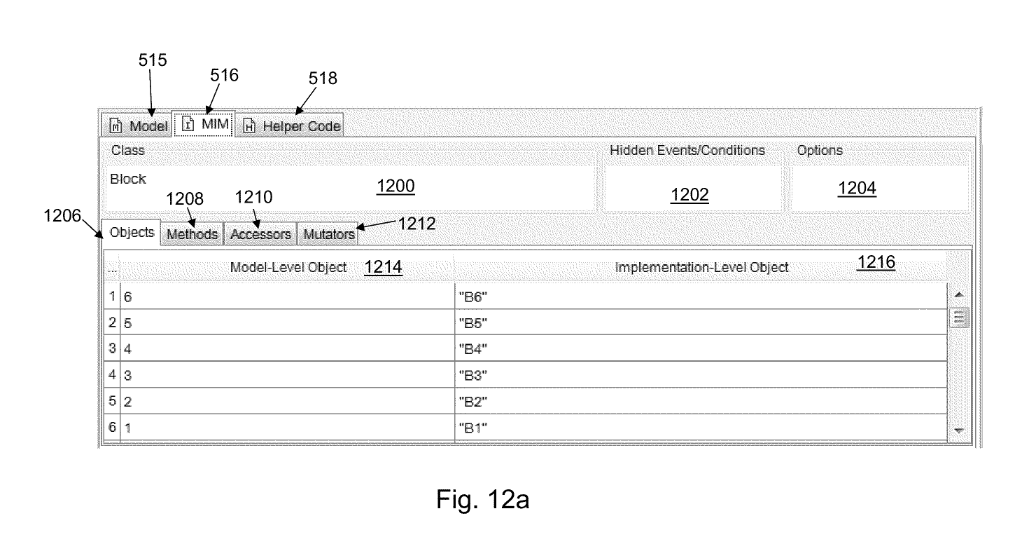

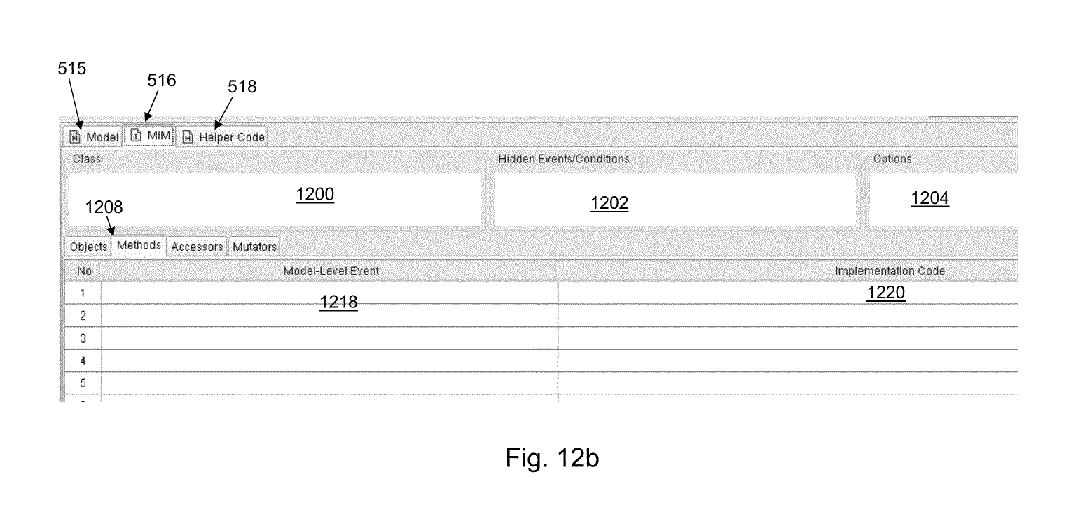

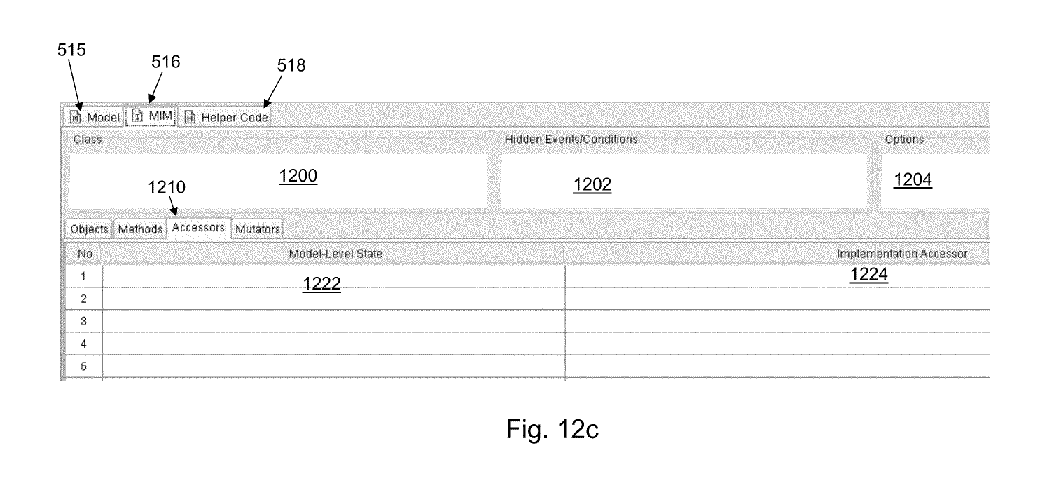

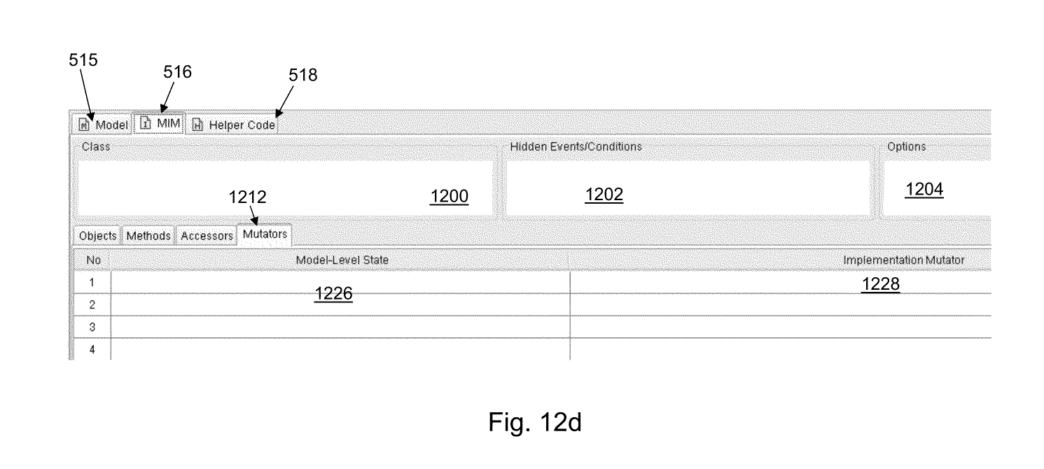

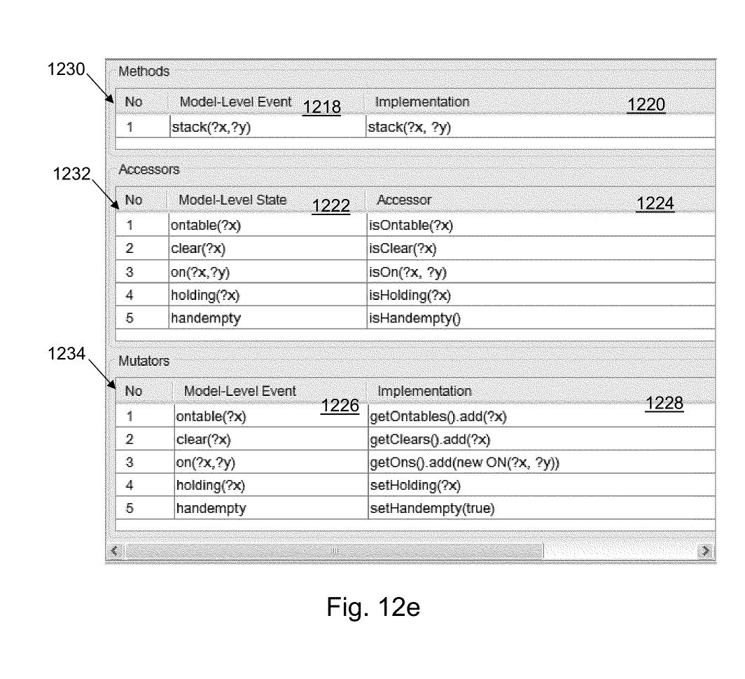

In an operation 420, an indicator is received by test code generation application 326, which is associated with creation of a MIM. With reference to FIGS. 12a-12d, MIM tab 516 is presented on second display 320 in accordance with an illustrative embodiment after the user selects MIM tab 516. A MIM maps individual elements in a test model into target code. Thus, the MIM specification maps the elements of the test model into implementation constructs for the purposes of test code generation. Building a MID does not require availability of the source code of the AUT 224.

MIM tab 516 may include a class window 1200, a hidden events window 1202, an options window 1204, an objects tab 1206, a methods tab 1208, an accessors tab 1210, and a mutators tab 1212. The user may select which of class window 1200, hidden events window 1202, and options window 1204 to include in MIM tab 516 for example using MIM selector 904. The user may select between objects tab 1206, methods tab 1208, accessors tab 1210, and mutators tab 1212. For example, with reference to FIG. 12a, the components of objects tab 1206 are shown; with reference to FIG. 12b, the components of methods tab 1208 are shown; with reference to FIG. 12c, the components of accessors tab 1210 are shown; and with reference to FIG. 12d, the components of mutators tab 1212 are shown.

Generally, the MIM specification depends on the model type. As an example, the identity of SUT device 200/AUT 224 to be tested against the test model is entered in class window 1200. The identity of SUT device 200/AUT 224 is the class name for an object-oriented program, function name for a C program, or URL of a web application. The identity may not be used when the target platform is Robot Framework. In the illustrative embodiment of FIG. 12a, the class under test is identified as Block in class window 1200. The keyword in MIM tab 516 may be CLASS, FUNCTION, or URL depending on the model type.

A list of hidden predicates in the test model that do not produce test code due to no counterpart in SUT device 200/AUT 224 is entered in hidden events window 1202. All events and places listed in hidden events window 1202 are defined in the test model. Multiple events and places are separated by “,”. As an option, the user may right-click using mouse 316 to bring up a list of events and places in the test model and select events and places from the list, which are translated into text and automatically entered in hidden events window 1202.

A list of option predicates in the test model that are implemented as system options in SUT device 200/AUT 224 is entered in options window 1204. A list of places that are used as system options and settings may be entered in options window 1204. An option in a test often needs to be setup properly through some code called a mutator. The places listed are defined in the function net. As an option, the user may right-click using mouse 316 to bring up a list of places in the test model and select places from the list, which are translated into text and automatically entered in options window 1204.

With reference to FIG. 12a, objects tab 1206 may include a model level object column 1214 which maps to items in an implementation level object column 1216. The object mapping between model level object column 1214 and implementation level object column 1216 maps objects (numbers, symbols, strings etc.) in the test model to object in SUT device 200/AUT 224. In the illustrative embodiment of FIG. 12a, objects 6 to 1 in the test model are mapped to objects “B6” to “B1” in SUT device 200/AUT 224. If a constant in the function net is not mapped between model level object column 1214 and implementation level object column 1216, the constant remains the same in the test code. For example, JavaBlocks may be used as a constant in a test model. In the implementation or test code, it can be the following named constant in SUT device 200/AUT 224 or helper code: static final String JavaBlocks=“..\\37 examples\\java\\blocks\\JavaBlockNet.xls”. As an option, when the user is editing a cell in model level object column 1214, the user may right-click using mouse 316 to trigger a popup menu that lists all of the constants defined in the transitions, initial states, and goal states of the test model and may select a constant from the list, which is automatically entered in the cell.

With reference to FIG. 12b, methods tab 1208 may include a model level event column 1218 which maps to items in an implementation code column 1220. The method mapping between model level event column 1218 and implementation code column 1220 maps calls of components in the test model to calls in SUT device 200/AUT 224. Methods are associated with transitions in the test model. Thus, model level event column 1218 maps individual events of the test model to a block of code in SUT device 200/AUT 224. If an event is not mapped and not listed in hidden events window 1202, the event remains the same in the test code. Each event specified here is of the form e(?x₁, . . . , ?xₘ), where e is the name and (?x₁, . . . , ?xₘ) are parameters. The parameters (?x₁, . . . , ?xₘ) correspond to the transition's formal parameters in the test model, but the names are independent. The number of parameters is the same as that in the corresponding event signature in the test model. The parameter names (?x₁, . . . , ?xₘ) are used as placeholders in the specified block of code for the event. As an option, when the user is editing a cell in model level event column 1218, the user may right-click using mouse 316 to trigger a popup menu that lists all of the events and their signatures defined in the test model and may select an event from the list, which is automatically entered in the cell.

With reference to FIG. 12c, accessors tab 1210 may include a model level state column 1222 which maps to items in an implementation accessor column 1224. Accessors provide a method for comparing an expected value to an actual value to verify that a state is correct or not. Model level state column 1222 maps parameterized tokens or places, called model-level states, into a block of code that typically verifies the state of SUT device 200/AUT 224. If a token is not mapped and its place name is not listed in hidden events window 1202, the token remains the same in the test code. Each model-level state specified in model level state column 1222 is of the form p(?xᵢ, . . . , ?xₘ), where p is the place name and (?x₁, . . . , ?xₘ) are parameters. The parameter names (?x₁, . . . , ?xₘ) are independent of the variables in the test model. However, the number of parameters is the same as the number of arguments of the place (i.e., number of arguments in associated arc labels) in the test model. The parameter names (?x₁, . . . , ?xₘ) are used as placeholders in the specified block of accessor code. As an option, when the user is editing a cell in model level state column 1222, the user may right-click using mouse 316 to trigger a popup menu that lists all of the places and the number of arguments defined in the test model and may select a place from the list, which is automatically entered in the cell.

With reference to FIG. 12d, mutators tab 1212 may include a second model level state column 1226 which maps to items in an implementation mutator column 1228. Mutators setup and change a state of an object. Second model level state column 1226 maps tokens (i.e., model-level states) into a block of code that achieves the desired state of SUT device 200/AUT 224. The syntax is the same as that for accessors. Mutators are typically used for places that are listed as options. A token in an option place in the test model is transformed into mutator code. The transformation is similar to that of accessor code.

With reference to FIG. 12e, a method table 1230 shows an example mapping between model level event column 1218 and implementation code column 1220. For example, component stack(?x, ?y) in the test model is mapped to method stack(?x,?y) in SUT device 200/AUT 224. This is the same for other components (unstuck, pickup, and putdown) not specified. An accessor table 1232 shows an example mapping between model level state column 1222 and implementation accessor column 1224. For example, ontable in the test model included in model level state column 1222 maps to is Ontable in SUT device 200/AUT 224 included in implementation accessor column 1224. A mutator table 1234 shows an example mapping between second model level state column 1226 and implementation mutator column 1228. For example, the mutator, ontable(?x), in the test model maps to getOntables( ) add(?x) in SUT device 200/AUT 224 included in implementation mutator column 1228.

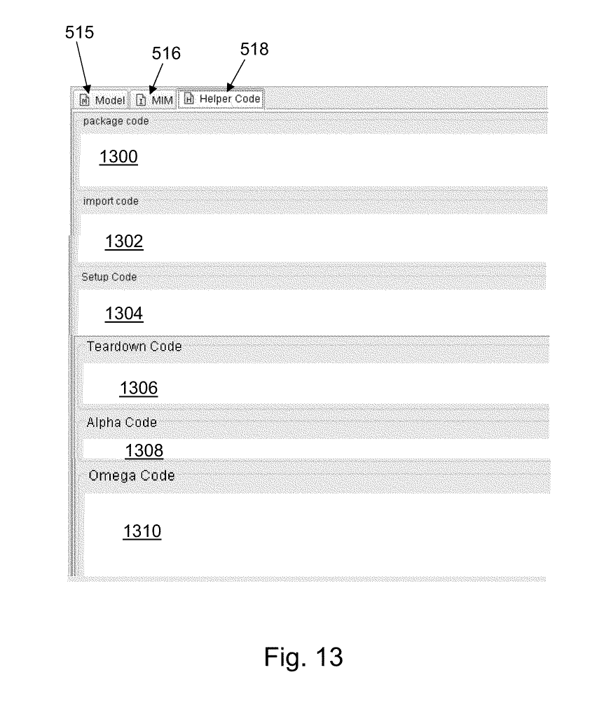

In an operation 422, an indicator is received by test code generation application 326, which is associated with creation of helper code. With reference to FIG. 13, helper tab 518 is presented on second display 320 in accordance with an illustrative embodiment after the user selects helper tab 518. Helper tab 518 allows the user to provide additional code that makes the generated test code executable, and of course, depends on the target language selected using test language selector 512. For example, Java test code generally needs package and import statements. In general, the helper code may include the header (for non-web applications), alpha/omega segments, setup/teardown methods, and local code (code segments, for non-web applications). For example, with reference to the illustrative embodiment of FIG. 13, helper tab 518 includes a package code window 1300, an import code window 1302, a setup code window 1304, a teardown code window 1306, an alpha code window 1308, and an omega code window 1310. The user may select which of the code windows to include in helper tab 518 for example using helper code selector 906.

Header code defined at that beginning of a test program may be entered in package code window 1300. In Java, the header includes package and import statements, whereas in C#, it includes namespace and using statements. HTML/Selenium test code for web applications does not need header code. For Robot Framework, the header code refers to “settings”. Variable/constant declarations and methods to be used within the generated test program may be entered in import code window 1302.

A setup method entered in setup code window 1304 is a piece of code called at the beginning of each test case. A teardown method entered in teardown code window 1306 is a piece of code called at the end of each test case. A test suite is a list of test cases. Alpha code entered in alpha code window 1308 is executed at the beginning of the test suite and omega code entered in omega code window 1310 is executed at the end of the test suite. Local code (or code segment): local code refers to the code that user provides, in addition to setup/teardown and alpha/omega. Local code may include (e.g., called by a setup or teardown method).

If the test code language selected using test language selector 512 is an object-oriented language (Java, C++, C#, VB) or C and no setup method/function is defined, test code generation application 326 generates it. The signature of the setup method/function is: void setup(for Java, C++, and C, and SetUp( ) for C# and VB. The signature of the teardown method/function is: void tearDown( ) for Java, C++, and C, and TearDown( ) for C# and VB.

In an operation 424, an indicator is received that indicates that a compilation of the MID is requested by the user. In an operation 426, the MID is compiled. In an operation 428, an indicator is received that indicates that a verification of the MID is requested by the user. In an operation 430, the selected verification of the MID is performed by test code generation application 326. In an operation 432, an indicator is received that indicates that a simulation of the MID is requested by the user. In an operation 434, the simulation of the MID is performed by test code generation application 326 under control of the user interacting with the controls presented in simulate control panel window 1102. Thus, the same controls associated with compiling, verifying, and simulating the test model also may be used to compile, verify, and simulate the MID of which the test model is one part.

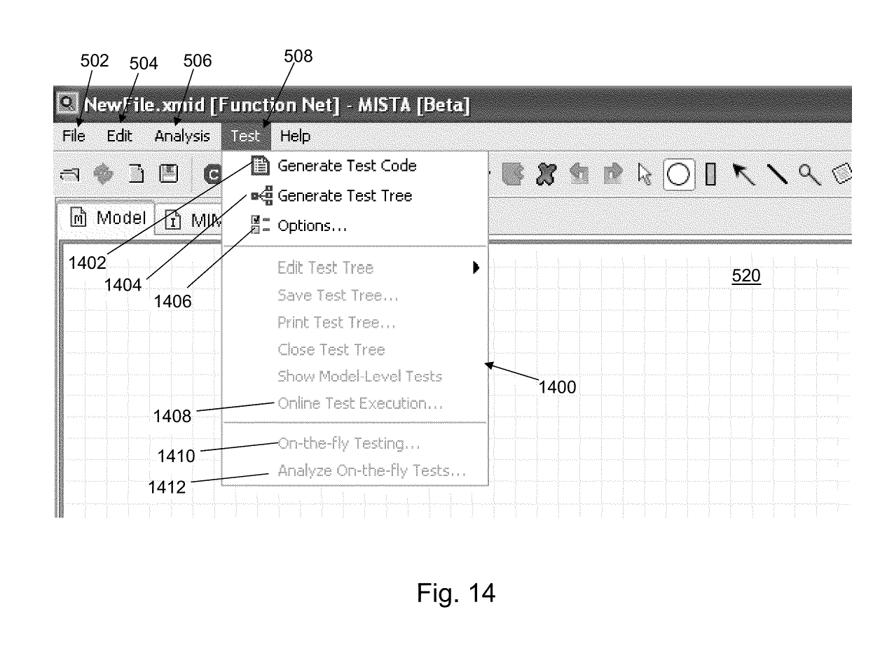

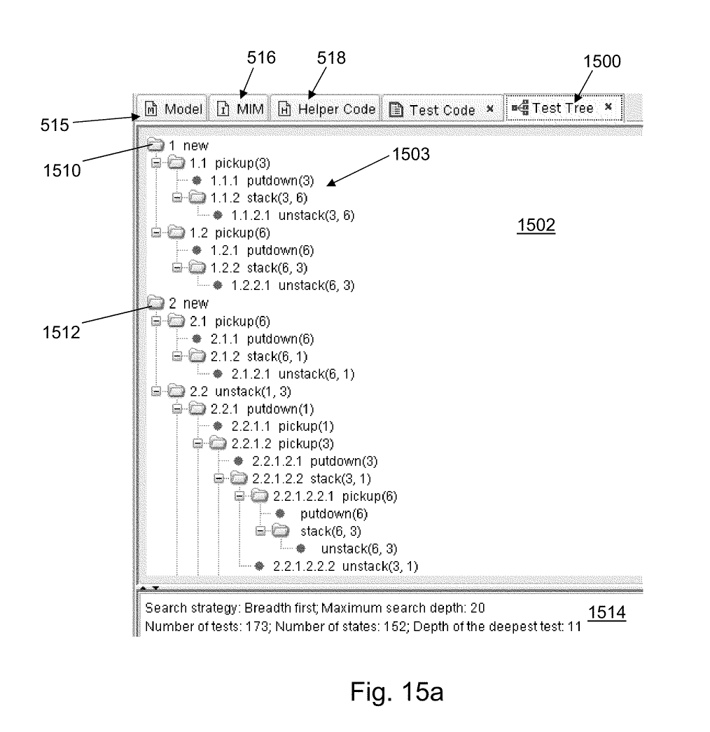

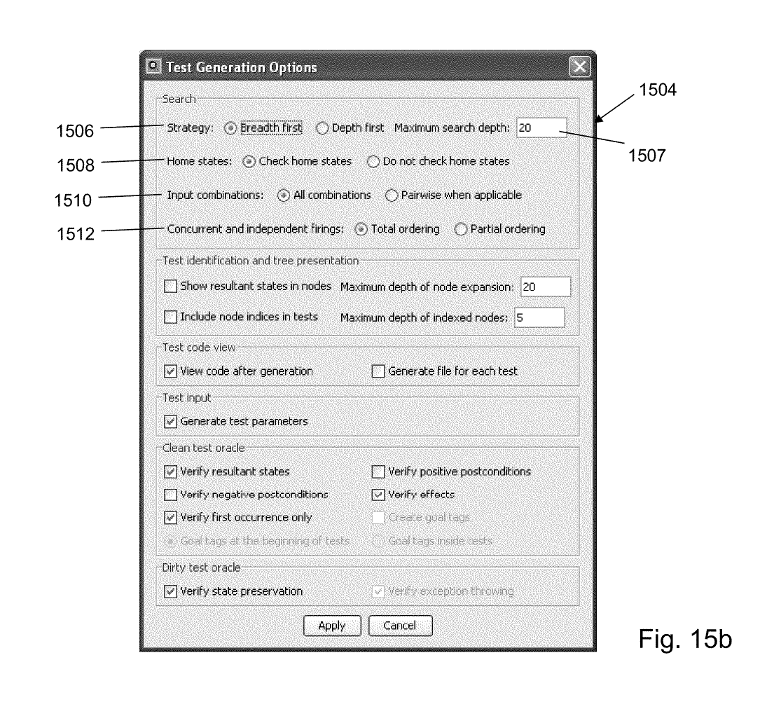

In an operation 436, an indicator is received by test code generation application 326 that indicates that a test tree generation is requested by the user. In an operation 438, the test tree is generated. With reference to FIG. 14, selection of test menu 508 may trigger creation of a test window 1400 shown in accordance with an illustrative embodiment. Test window 1400 may include a generate test code selector 1402, a generate test tree selector 1404, an options selector 1406, an online test execution selector 1408, an on the fly testing selector 1410, and an analyze on the fly selector 1412. With reference to FIG. 15a, receipt of an indicator indicating user selection of generate test tree selector 1404 triggers generation of a test tree tab 1500 and a test tree window 1502 presented in test tree tab 1500.

Test tree tab 1500 is generated from the working MID under the current settings (e.g., test coverage criterion). A test case includes a sequence of test inputs (component/system calls) and respective assertions (test oracles). Each assertion compares the actual system state against the expected result to determine whether the test passes or fails. Each test case may call the setup method in the beginning of the test and the teardown method at the end of the test. Test sequence generation produces a test suite, i.e., a set of test sequences (firing sequences) from the test model according to the selected coverage criterion. The test sequences are organized as a transition tree or test tree. The root represents the initial state resulting from the new operation, like object construction in an object-oriented language. Each path from the root to a leaf is a firing sequence. The entire tree represents a test suite and each firing sequence from the root to a leaf is a test case.

Test tree tab 1500 may include four windows: test tree window 1502, a test sequence window (not shown), a test information window 1514, and a test code window (not shown). A test tree 1503 is presented in test tree window 1502 and includes a first node 1510 denoted “1 new”, which is a root of test tree 1503 associated with the first initial state. A second node 1512 denoted “2 new” is a root of test tree 1503 for the second initial state. The user may select a node from test tree 1503, for example, using mouse 316. After selecting a node, information about the selected node is shown in test information window 1514. The test sequence window presents the test sequence from the root to the selected node. The test code window presents the test code for the selected node. Generally, test parameters are generated automatically from the test model. Test code generation application 326 also allows test parameters and code to be edited manually using the test sequence window. Once a test tree has been generated, test parameters or test code may be specified for any test node by selecting the test node from test tree 1503 and providing the actual parameter in a parameter box created in the test sequence window. If a “parameter” checkbox associated with the parameter box is selected, the input is used as a parameter, otherwise it is inserted as code. If there are multiple parameters or statements, they appear in the test code in the specified order.

Test tree generation may depend on options selected by the user. For example, with reference to FIG. 15b, receipt of an indicator indicating user selection of options selector 1406 triggers generation of an options window 1504. Options window 1504 may include a strategy selector 1506, a maximum depth selector 1507, a home states selector 1508, an input combinations selector 1510, and a firing strategy selector 1512 among other options. Use of strategy selector 1506 allows the user to select between a breadth first or a depth first option. This option applies to reachability tree coverage, reachability tree coverage with dirty tests, transition coverage, state coverage, depth coverage, goal coverage, and deadlock/termination state coverage, but does not apply to random test code generation or given sequences. Use of maximum depth selector 1507 allows the user to select a zmaximum depth. This option applies to all coverage criteria except for given sequences.

Use of home states selector 1508 allows the user to select a home state, which is an initial state (marking) that is reached by a non-empty sequence of transition firings from itself. Home states selector 1508 applies to reachability analysis and test code generation for state coverage. When verifying the reachability of a goal marking that is the same as an initial marking, “Check home states” is to check if this marking is a home state, i.e., try to find a firing sequence that reaches this marking from itself. “Do not check home states” does not check if the marking is a home state—it is simply reachable from itself with an empty firing sequence. When generating tests for state coverage, “Check home states” create tests to cover the initial markings if possible. For example, if a function net has four possible states s0, s1, s2, and s3, where s0 is the initial state. “Check home states” will generate tests to cover four states if s0 is a home state. “Do not check home states” will create tests to cover s1, s2, and s3 no matter whether or not s0 is a home state.

Use of input combinations selector 1510 allows the user to either apply all combinations according to the general rule of transition firings or pairwise input combinations for transition firings when applicable. Pairwise is applicable to those transitions that have more than two input places, no inhibitor places, and no guard condition.

Use of firing strategy selector 1512 allows the user to select the ordering of concurrent and independent firings. Total ordering refers to generation of all interleaving sequences, whereas partial ordering yields one sequence. For example, if there are six interleaving sequences of three independent firings, when partial ordering is used, only one of them is created. This sequence can depend on the ordering in which the transitions are defined.

Another option that may be included in options window 1504 allows the user to select between using the actual parameters of transition firings in tests or discarding the actual parameters of the transition firings and allowing the user to edit the test parameters manually. Another option allows the user to declare an object reference when an object-oriented language is used and AUT 224 is a class or the head class of a cluster. A variable of this class is declared. When this option is selected, an add object reference is automatically added to the beginning of each method/accessor/mutator. Another option allows the user to verify result states such that each token in the resultant state of each transition firing is used as a test oracle unless its place is listed in hidden events window 1202. Another option allows the user to verify a positive postcondition such that new tokens from each transition firing are used as test oracles unless their places are listed in hidden events window 1202. Another option allows the user to verify a negative postcondition such that removed tokens due to each transition firing are used as test oracles unless their places are listed in hidden events window 1202. Another option allows the user to verify on the first occurrence only to avoid repeating the oracles of the same test inputs in different tests to improve performance. It does not affect the test code of the selected test in the test tree, where the oracles of all test inputs are generated. Another option allows the user to verify effects such that effects associated with transitions are used as test oracles. Another option allows the user to verify state preservation such that, in a dirty test, the last transition firing or test input is invalid. State preservation means that this invalid test input does not change the system state. Thus, the tokens in the marking before the invalid transition firing can be used as test oracles. Another option allows the user to verify exception throwing such that an exception is thrown when the invalid transition firing is attempted.

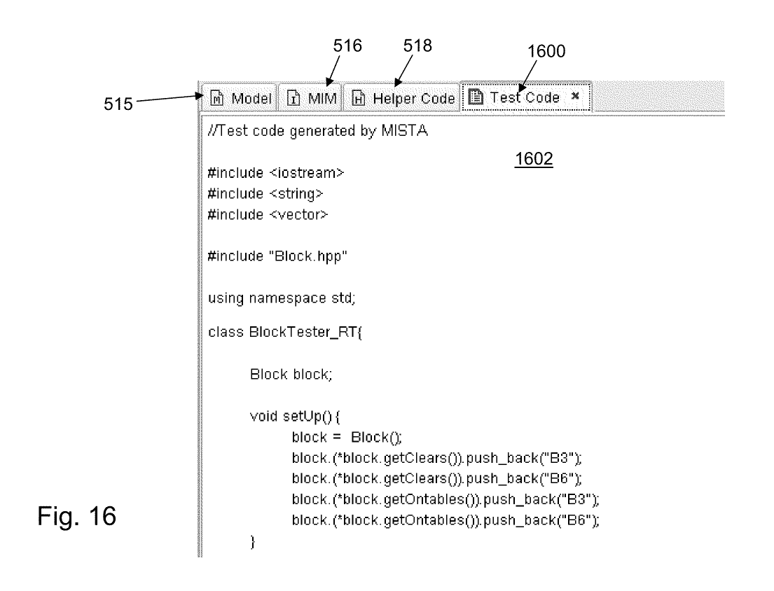

In an operation 440, an indicator is received by test code generation application 326 that indicates that a test code generation is requested by the user. In an operation 442, the test code is generated. With reference to FIG. 16, receipt of an indicator indicating user selection of generate test code selector 1402 triggers generation of a test code tab 1600 and test code 1602 presented in test code tab 1600. The object-oriented (Java, C++, C#, and VB) test code is one or more classes, depending on whether or not a separate file is generated for each test or a single file includes all of the tests in the test tree. The structure of the single test class in Java consists of a header (e.g., package and import statements) from the helper code, a class declaration according to the given class name in MIM (or MID file name if class name is not specified), a declaration of object reference according to the given class name if the option “Declare object reference” is checked, a setup method from the helper code, a teardown method from the helper code, a method for each test according to the specifications of objects, methods, accessors, and mutators in defined in the MIM, code segments copied from the helper code, a test suite method (the testAll method) that invokes the alpha code in the helper code, each test method, and the omega code in the helper code, and a test driver (i.e., the main method). When a test framework (e.g., JUnit) is used, the test suite method and the test driver are not generated. This indicates that the alpha and omega code in the helper code is not used.

In an operation 444, an indicator is received by test code generation application 326 that indicates that a test code execution is requested by the user. In an operation 446, the test code is executed. Receipt of an indicator indicating user selection of online test execution selector 1408 or on the fly testing selector 1410 triggers execution of test code 1602 presented in test code tab 1600. Selection of on the fly testing selector 1410 triggers creation of a control panel similar to simulate control panel window 1102; however, the test inputs and test oracles of transition firings are executed on the server. Again, step wise test execution and random test execution can be performed under control of the user through interaction with the created control panel. Continuous testing terminates if one of the following conditions occurs: (1) the test has failed, (2) the test cannot be performed (e.g., due to a network problem), (3) no transition is firable, or (4) the test has exceeded the maximum search depth. If “Automatic restart” is checked, the continuous random testing will be repeated until execution stops, is reset or is exited. If there are multiple initial markings, the repeated random testing also randomly chooses an initial marking.

Receipt of an indicator indicating user selection of analyze on the fly selector 1412 allows the user to analyze the executed tests by reviewing test logs.

Function nets can also be used to model security threats, which are potential attacks against SUT device 102/AUT 224. To do so, a special class of transitions, called attack transitions, is defined. Attack transitions are similar to other transitions except that their names start with “attack”. When a Function net is a threat model, the firing sequences that end with the firing of an attack transition are of primary interest. Such a firing sequence may be called an attack path, indicating a particular way to attack SUT device 102/AUT 224. Using formal threat models for security testing can better meet the need of security testing to consider the presence of an intelligent adversary bent on breaking the system. Threat models may be built systematically by examining all potential STRIDE (spoofing identity, tampering with data, repudiation, information disclosure, denial of service, and elevation of privilege) threats to system functions.

Threat models are built by identifying the system functions (including assets such as data) and security goals (e.g., confidentiality, integrity, and availability) for SUT device 102/AUT 224. For each function, how it can be misused or abused to threaten its security goals is identified using the STRIDE threat classification system to elicit security threats in a systematic way. Threat nets (threat test models) are created to represent the threats. A threat net describes interrelated security threats in terms of system functions and threat types. The threat nets are analyzed through reachability analysis or simulation and the threat models revised if the analysis reports any problems.

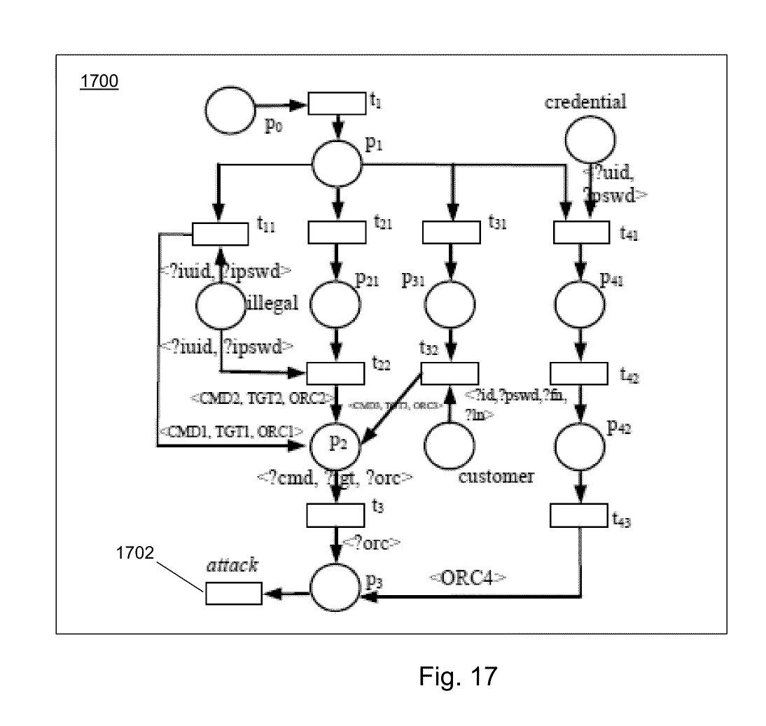

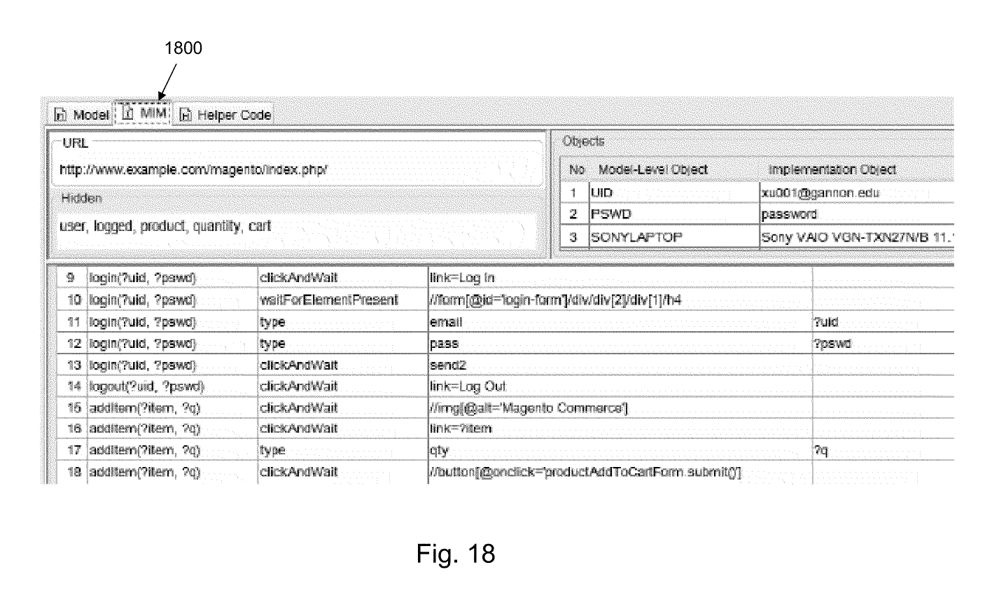

With reference to FIG. 17, a first threat function net 1700 that models a group of XSS (Cross Site Scripting) threats is shown in accordance with an illustrative embodiment. First threat function net 1700 captures several ways to exploit system functions by entering a script into an input field, such as email address, password, or coupon code. The functions are log in (t1, t11, t3), create account (t1, t21, t22, t3), forgot password (t1, t31, t32, t3), and shopping with discount coupon (t1, t41, t42, t43, t3). First threat function net 1700 includes an attack transition 1702. With reference to FIG. 18, a portion of the MIM 1800 for first threat function net 1700 is shown in accordance with an illustrative embodiment. UID and PSWD are two objects in the test model, representing user id and password. When they appear in a test case, they refer to xu001@gannon.edu and password in the SUT, respectively. Rows 9-18 of MIM 1800 are part of the method mapping. Rows 9-13 are Selenium IDE commands for login, and row 14 is the Selenium IDE command for logout.

Automated generation of security test code largely depends on whether or not threat models can be formally specified, whether or not individual test inputs (e.g., attack actions with particular input data) and test oracles (e.g., for checking system states) can be programmed. A system that is designed for testability and traceability facilitates automating its security testing process. For example, threat models identified and documented in the design phase can be reused for security test code generation. Accessor methods designed for testability (i.e., for accessing system states) are useful for verification of security test oracles. The traceability of design-level functions in the implementation can facilitate the mapping from individual actions in threat models to implementation constructs. The threat models can be built at different levels of abstraction. They do not necessarily specify design-level security threats.

A threat model describes how the adversary may perform attacks to violate a security goal. A function net N is a tuple <P, T, F, I, Σ, L, φ, M₀>, where P is a set of places (i.e., predicates), T is a set of transitions, F is a set of normal arcs, and I is a set of inhibitor arcs, Σ is a set of constants, relations (e.g., equal to and greater than), and arithmetic operations (e.g., addition and subtraction), L is a labeling function on arcs F∪I. L(ƒ) is a label for arc ƒ. Each label is a tuple of variables and/or constants in τ. φ is a guard function on T. φ(t),t's guard condition, is built from variables and the constants, relations, and arithmetic operations in Σ. M₀=U_{pεP}M₀(p) is an initial marking, M₀(p) is the set of tokens in place p. Each token is a tuple of constants in Σ.

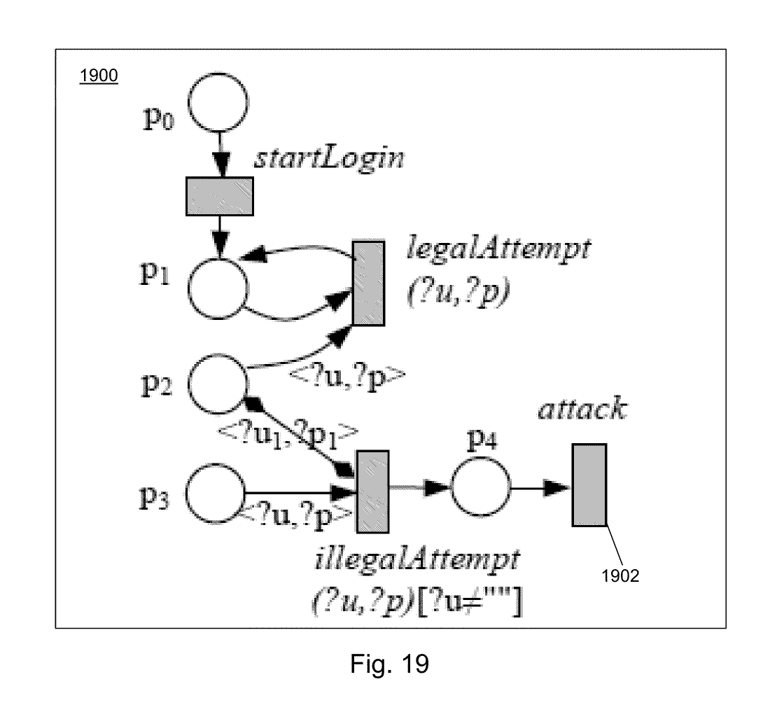

Suppose each variable starts with a lower-case letter or question mark and each constant starts with an upper-case letter or digit. <¢> denotes the zero-argument tuple for a token or default arc label if an arc is not labeled. p(V₁, . . . , Vₙ) denotes denotes token <V₁, . . . , Vₙ> in place p. A line segment with a small solid diamond on both ends represents an inhibitor arc. For example, a second threat function net 1900 is shown in accordance with an illustrative embodiment in FIG. 19. Second threat function net 1900 includes an attack transition 1902. Transitions legalAttempt and illegalAttempt have formal parameters (?u, ?p). illegalAttempt also has a guard condition ??u≠“ ”. If t is a transition, p is called an input (or output) place of t if there is a normal arc from p to t (or from t to p). p is called an inhibitor place if there is an inhibitor arc between p and t. Let ?x/V be a variable binding, where ?x is bound to value V. A substitution is a set of variable bindings. In substitution {?u/ID1,?p/PSWD1}, ?u and ?p are bound to ID1 and PSWD1, respectively. Let θ be a substitution and l be an arc label, l/θ denotes the tuple (or token) obtained by substituting each variable in l for its bound value in θ. If l=<?u,?p> and θ={?u/ID1,?p/PSWD1}, then l/θ=<ID1,PSWD1>. Transition t is said to be enabled or firable by θ under a marking if (a) each input place p of t has a token that matches l/θ, where l is the normal arc label from p to t; (b) each inhibitor place p of t has no token that matches l/θ, where/is the inhibitor arc label; and (c) the guard condition of t evaluates to true according to θ. Suppose M₀={p₁,p₂(ID1,PSWD1),p₃(IDn+1, PSWDn+1)} for second threat function net 1900. legalAttempt is enabled by θ={?u/ID1,?p/PSWD1} because p₁ has a token (i.e., <¢>) and p₂ have a token <ID1,PSWD1> that matches <?u,?p>/θ. illegalAttempt is not enabled under M0 because p₂, as an inhibitor place, has a token that can be unified with the arc label <?u1,?p1>. Inhibitor arcs represent negation. Firing an enabled transition t with substitution θ under M₀ removes the matching token from each input place and adds new token l/θ to each output place, where l is the arc label from t to the output place. This leads to a new marking M₁. Firing t(?x1, . . . , ?xn) with ={?x1/V1, . . . , ?xn/Vn} is denoted by tθ or t(V1, . . . , Vn). M₀,t₁θ₁,M₁ . . . tₙθₙ,Mₙ, or simply t₁θ₁, . . . , tₙθₙ, is called a firing sequence, where tᵢ(1≦i≦n) is a transition, (1≦i≦n) is the substitution for firing tᵢ, and Mᵢ (1≦i≦n) is the marking after tᵢ fires, respectively. A marking M is said to be reachable from M₀ if there is such a firing sequence that transforms M₀ to M. Evaluation of a guard condition for transition firing may involve comparisons, arithmetic operations, and binding of free variables to values. Therefore, a firing sequence can imply a sequence of data transformations.

A function net <P,T,F,I,Σ,L,φ,M₀> is a threat model or net if T has one or more attack transitions (suppose the name of each attack transition starts with “attack”). The firing of an attack transition is a security attack or a significant sign of security vulnerability. Second threat function net 1900 models a dictionary attack against a system that allows only n invalid login attempts for authentication. It describes that the adversary tries to makes n+1 login attempts. p₂ holds n invalid <user id, password> pairs and p₃ holds one invalid <user id, password> pair. Suppose M0={p₀, p₂(ID1, PSWD1),p₂(ID2, PSWD2),p₂(ID3, PSWD3),p₃(IDn+1, PSWDn+1. Then the following firing sequence violates the authentication policy of a system that allows only three invalid login attempts:

M₀, startLogin, M₁, legalAttempt(ID1, PSWD1), M₂, legalAttempt(ID2, PSWD2), M₃, legalAttempt(ID3, PSWD3), M₄, illegalAttempt(IDn+1, PSWDn+1), M₅, attack, M₆ where Mᵢ (1≦i≦6) are the markings after the respective transition firings.

A MIM specification for a threat model N=<P,T,F,I,Σ,L,φ,M₀> is a quadruple <SID, ƒ₀, ƒ_{PT}, ƒ_{H}>, where: (1) SID is the identity or URL of the SUT. (2) ƒ₀: Σ→O^{£} maps constants in Σ to expressions in £. (3) ƒ_{PT}: P∪T→P£ maps each place and transition in P∪T to a block of code in £. (4) ƒ_{H}: {HEADER}→P£ is the header code in £. It is included in the beginning of a test suite (e.g., #include and variable declarations in C). ƒ₀, called object function, maps each constant (object or value) in a token, arc label, or transition firing of the threat net to an expression in the implementation. For example, a login ID in a threat net may be corresponding to an email address in a SUT. ƒ_{PT}, called place/transition mapping function, translates each place or transition into a block of code in the implementation. ƒ_{H}, called helper function, specifies the header code that is needed to make test code executable.

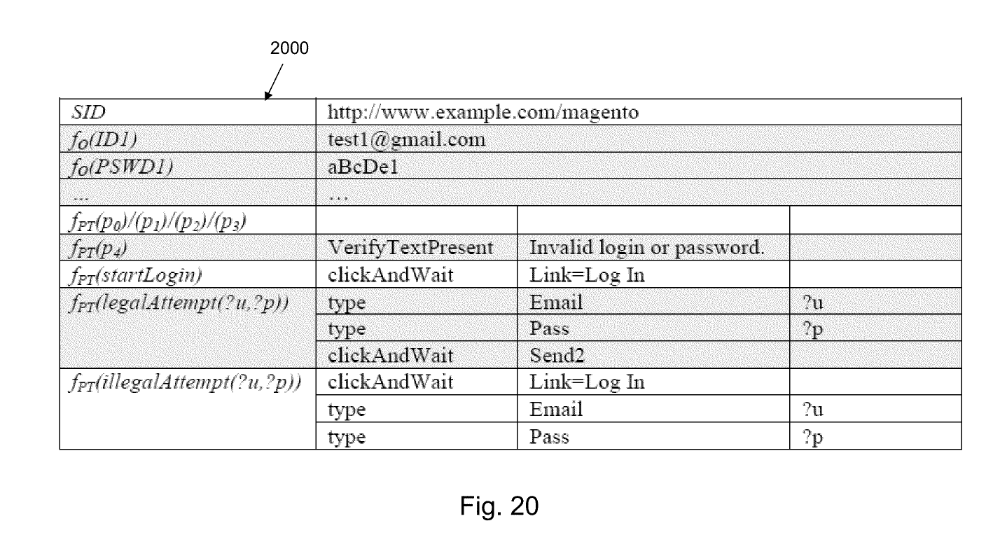

FIG. 20 shows a portion 2000 of the MIM specification for second threat function net 1900. The SUT is a web application at http://www.example.com/magento. The target language is HTML/Selenium. Each Selenium operation is a triple <command, target, value>, i.e., columns 2-4 of those rows with four columns in portion 2000. ID1 and PSWD1 from the threat model correspond to test1@gmail.com and aBcDe1, respectively. ƒ_{PT}(p) for place p can be used to set up test conditions or evaluate test oracles. For example, ƒ_{PT}(p₄) in FIG. 20, as a test oracle, verifies whether or not the response from the SUT contains the text “invalid login or password” after the n+1 login attempt. The presence of this text implies that the SUT has accepted the login attempt. Test oracles (including expected results and comparisons with actual results) are important for determining whether security tests pass or fail. In model-based testing, test models and the SUT are often at different levels of abstraction. Model-level test oracles (tokens in markings of attack paths) can be directly mapped to implementation-level code if they are programmable (like ƒ_{PT}(p₄) in FIG. 20). ƒ_{PT}(p₀)=ƒ_{PT}(p₁)=ƒ_{PT}(p₂)=ƒ_{PT}(p₃)= (empty) because they are not used to generate test code in the illustrative embodiment. ƒ_{PT}(t) for transition t usually performs one or more operations. startLogin is done by clicking on the link “Log In”, whereas legalAttempt is accomplished by filling in the Email and Pass fields and submitting the request.

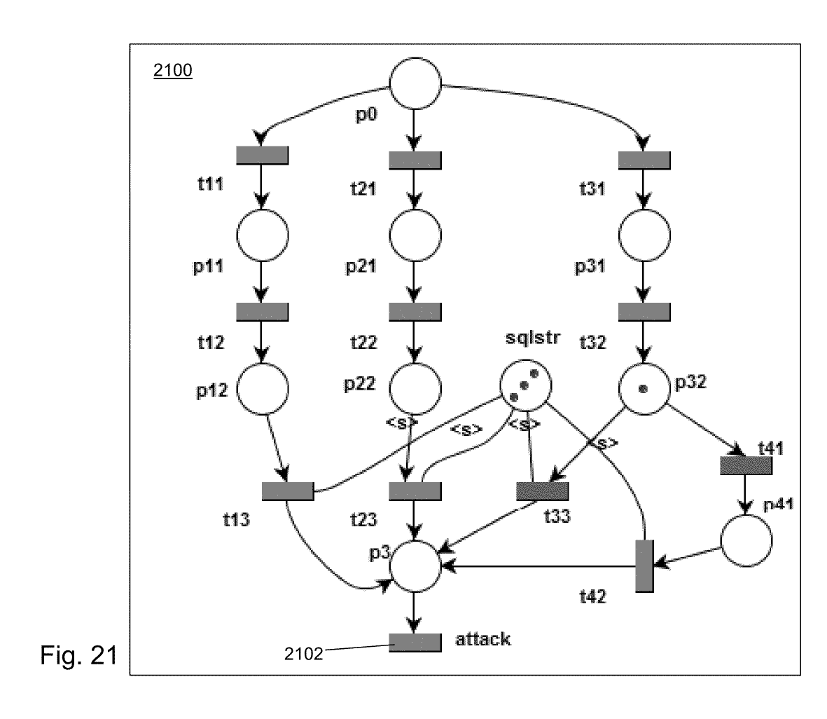

With reference to FIG. 21, a threat net 2100 of some SQL injection attacks against the Magento shopping system are shown in accordance with an illustrative embodiment. Threat net 2100 includes an attack transition 2102. The attacks can be done with respect to several functional scenarios, such as “do shopping, login, and check out” (transitions t11, t12, t13), “go to login page and retrieve password through ‘Forgot your password’” (t21, t22, t23), “login, do shopping, and check out using coupon code” (t31, t32, t33), and “login, do shopping, check out using credit card payment” (t31, t32, t41, t42). They can lead to different types of security threats, such as information disclosure and data tampering. Place sqlstr represents different SQL injection strings that can be used to attack these functions. The different string attacks can be denoted as INJECTION1, INJECTION2, and INJECTION3, respectively. Threat net 2100 makes it possible to generate injection attacks automatically against the relevant functions.

In a threat net, the initial marking (i.e., a distribution of tokens in places) may represent test data, system settings and states (e.g., configuration), and ordering constraints on the transitions. The attack paths in a threat net depend on not only the structure of the net but also the given initial marking. Consider an initial marking of threat net 2100: {p₀, sqlstr (INJECTION1), sqlstr (INJECTION2), sqlstr (INJECTION3)}. sqlstr represents malicious inputs for testing SQL injection attacks. (t₁₁, t₁₂, t₁₃) is a meaningful attack path only when t₁₃ uses a malicious SQL injection input that is provided in place sqlstr. It is not a security test if the input of t₁₃ is a normal valid input. This is similar for other attack paths. Different attack paths may have the same transitions with different substitutions (i.e., test values) for the transition firings. Thus, test data specified in an initial marking are important for exposing security vulnerabilities. They determine the specific test values that would trigger security failures. The test values may be created based on a user's expertise (e.g., SQL injection strings) or produced by tools that generate random invalid values of variables. A threat net can be verified through reachability analysis of goal markings and reachability analysis of transitions. FIG. 21 shows the state of threat net 2100 after t₃₁ and t₃₂ have been fired. There are three tokens in sqlstr (i.e., INJECTION1, INJECTION2, INJECTION3) and one token in p₃₂. t₃₃ and t₄₁ are enabled. t₃₃ is enabled by three different substitutions: s/INJECTION1,s/INJECTION2, s/INJECTION3. Similarly, firing t₄₁ enables t₄₂ by three substitutions. Therefore, there are six attack paths from t₃₁ and t₃₂ to the attack transition.

Attack paths can be generated from the threat net even if the MIM description is not provided. In a threat net, each attack path M₀, t₁θ₁, M₁, . . . , tₙ₋₁θₙ₋₁, Mₙ₋₁, tₙθₙ, Mₙ (tₙ is an attack transition) is a security test, where: M₀ is the initial test setting, t₁θ₁, . . . , tₙ₋₁θₙ₋₁ are test inputs, M₁, . . . , Mₙ₋₁ are the expected states (test oracles) after tᵢθᵢ (1≦i≦n−1), respectively. For each pεP, p(V₁, . . . , Vₘ)εMᵢ(1≦i≦n−1) is an oracle to be evaluated. Attack transition tₙ and its resultant marking Mₙ represent the logical condition and state of the security attack or risk. They are not treated as part of the real test because they are not physical operations. A security test fails if there is an oracle value that evaluates to false. It means that SUT device 200/AUT 224 is not threatened by the attack. The successful execution of a security test, however, means that SUT device 200/AUT 224 suffers from the security attack or risk.

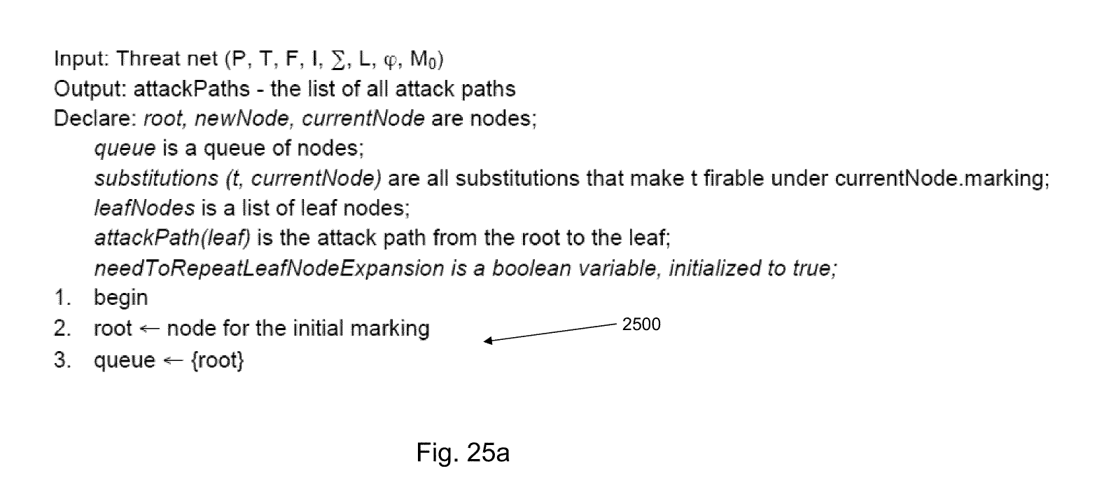

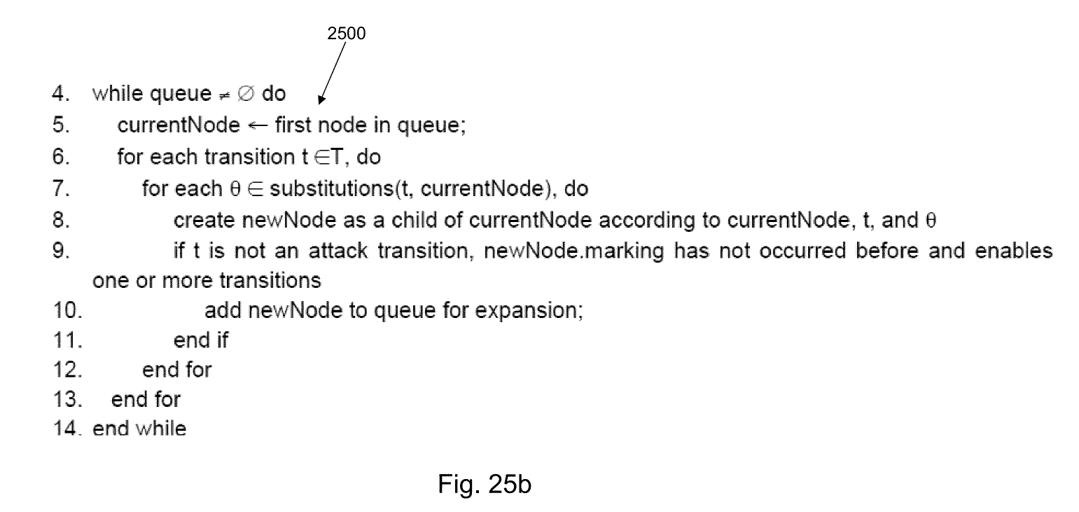

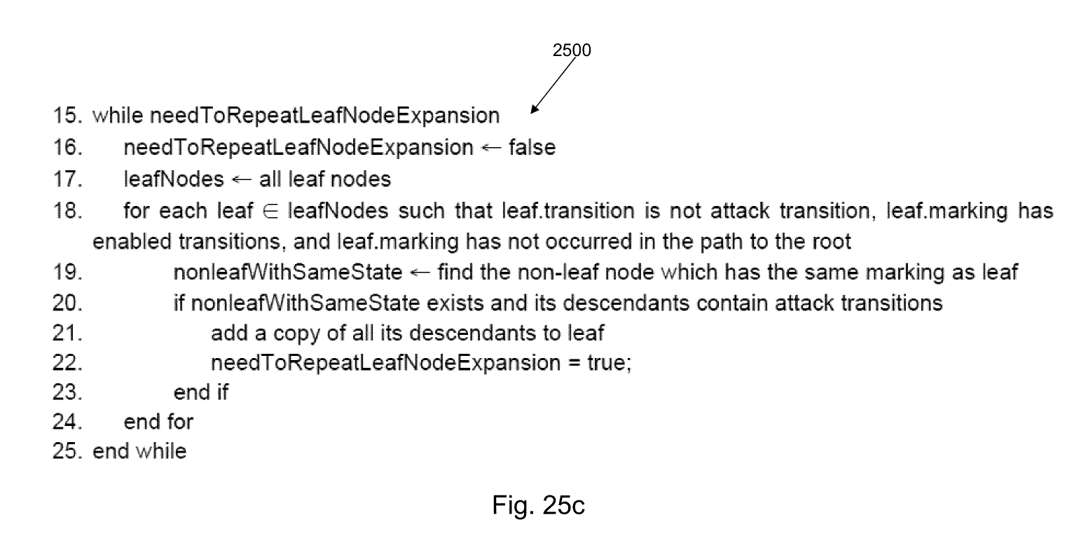

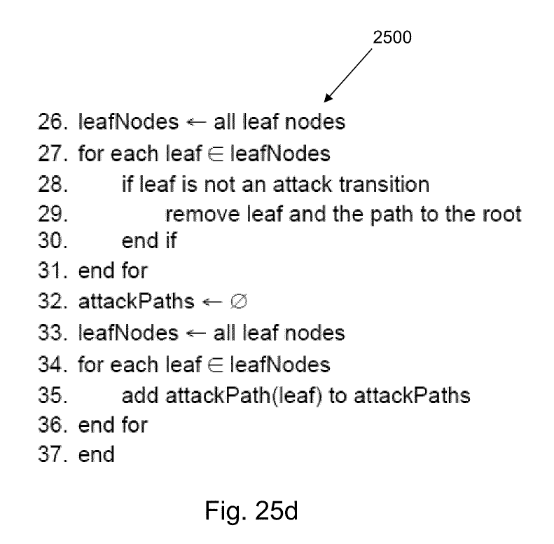

A second algorithm 2500 is shown in FIGS. 25a-25d, in accordance with an illustrative embodiment, to describe how all attack paths are generated from a given threat net. A reachability graph of the threat net is generated in lines 2-14 of second algorithm 2500. The reachability graph represents all states (markings) and state transitions reachable from the initial marking. Construction of the reachability graph starts with expanding the root node. When a node is expanded, all possible transition firings (all substitutions for each transition) under the current marking are computed and a child node is created for each possible firing. The child node is also expanded unless it results from the firing of the attack transition or the current marking has expanded before.

The generated reachability graph is transformed to a transition tree that contains complete attack paths. This is done by repeatedly expanding the leaf nodes that are involved in attack paths, but do not result from firings of attack transitions (lines 15-25, initially needToRepeatLeafNodeExpansion=true). Once the expansion starts, needToRepeatLeafNodeExpansion is set to false (line 16), assuming that the expansion is not repeated unless it is needed. Different attack paths in a threat net can lead to the same marking. For termination purposes, the generation of reachability graph (lines 2-14) does not expand the same marking more than once. For different attack paths leading to the same marking, some of them will not end with attack transitions in the reachability graph. Specifically, if a leaf node does not result from the firing of an attack transition, but its marking enables some transitions (line 18), the marking must have been expanded before—there exists a non-leaf node that contains the same marking. The leaf node is in attack paths if this non-leaf node with the same marking contains attack transitions in its descendants. Therefore, such a non-leaf node is found (line 19) and, if its descendants contain attack transitions, a copy of the descendants is attached to the leaf (line 21). In this case, the leaf nodes copied from the descendants may also need to be expanded. needToRepeatLeafNodeExpansion is set to true so that there is another round of leaf node expansion.

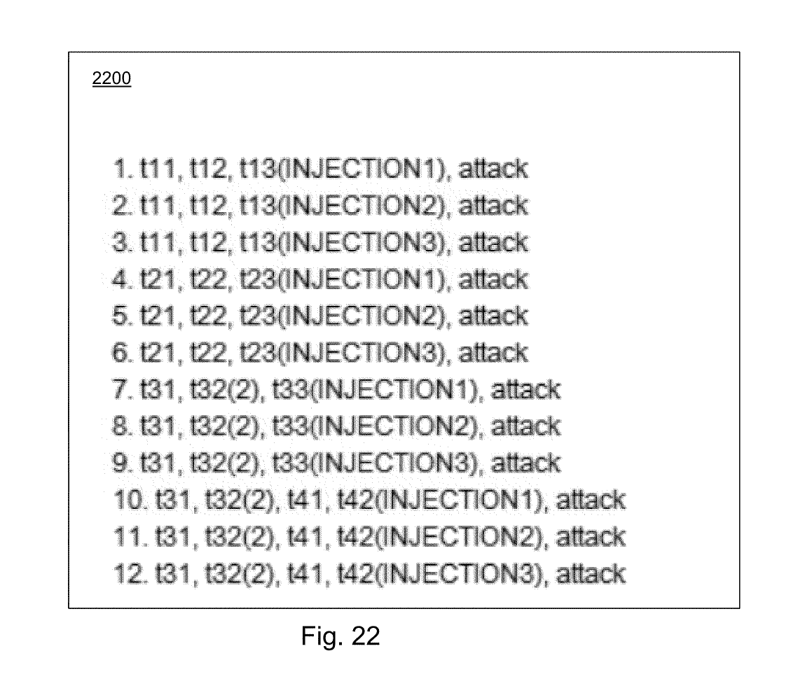

To avoid duplicate expansion leaf nodes in attack paths, an additional constraint is added to the condition for leaf node expansion: the marking of the leaf node has not occurred in the path from the leaf node to the root (line 18). The leaf nodes that do not represent attack paths are removed (lines 26-31) if the focus is on security testing. As a result, each leaf node in the final transition tree implies the firing of an attack transition and each path from the root to a leaf is an attack path. Attack paths are generated by collecting all leaf nodes and, for each leaf, retrieving the attack path from the root to the leaf (lines 32-36). Each attack path ends with a attack transition—no node firing an attack transition is expanded. For a composite attack that is composed of a sequence of attacks, only one attack transition is specified in the attack path when building the threat net. With reference to FIG. 22, attack paths 2200 generated from threat net 2100. There are 12 attack paths—the threat net involves four functional scenarios (i.e., login, retrieval of password, coupon code, and credit card payment) that can be affected by SQL injection and any of the three SQL injection strings can be used for the attack. Obviously, manual creation and maintenance of such attack paths would be tedious and error-prone.

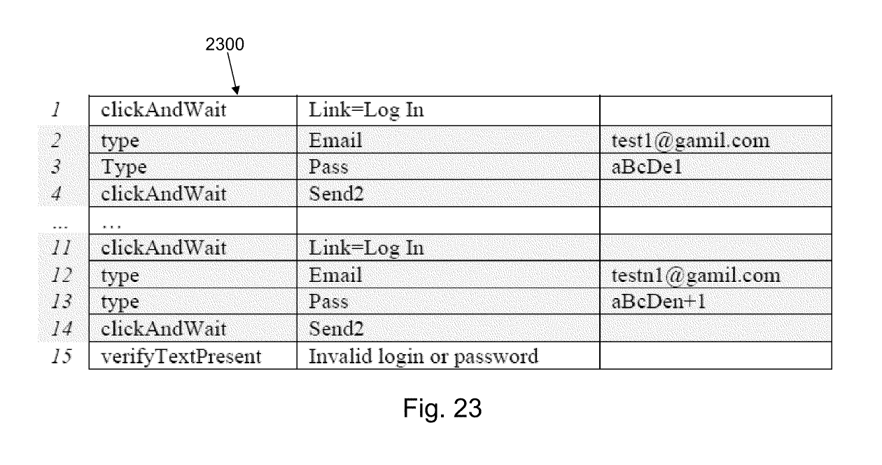

Sample HTML/Selenium code 2300 is shown in FIG. 23. Generation of test code in C is similar to Algorithm 2. The main differences are: each test is defined as a function, the main function issues one call to each test, the test suite file consists of the header, the setup function, the functions for all tests, and the main function. As such, Algorithm 2 can be adapted as follows: lines 3-6 create the setup function, line 8 calls the setup function; lines 9-15 create a function for each test; line 16 appends a test call to the main function.

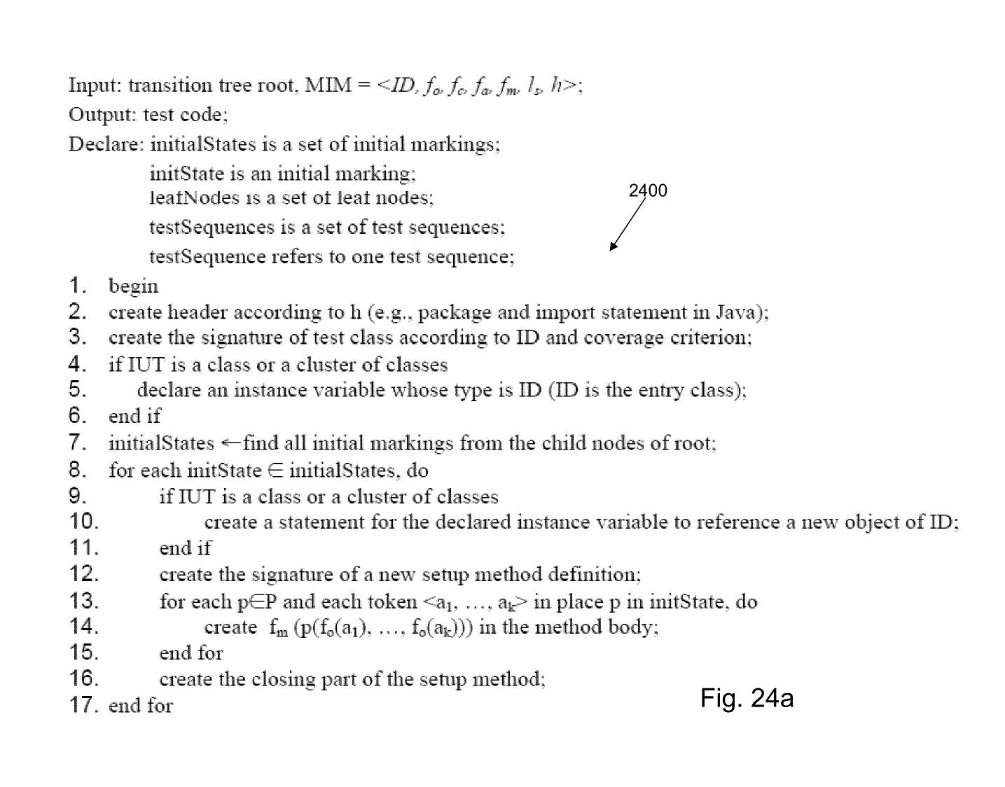

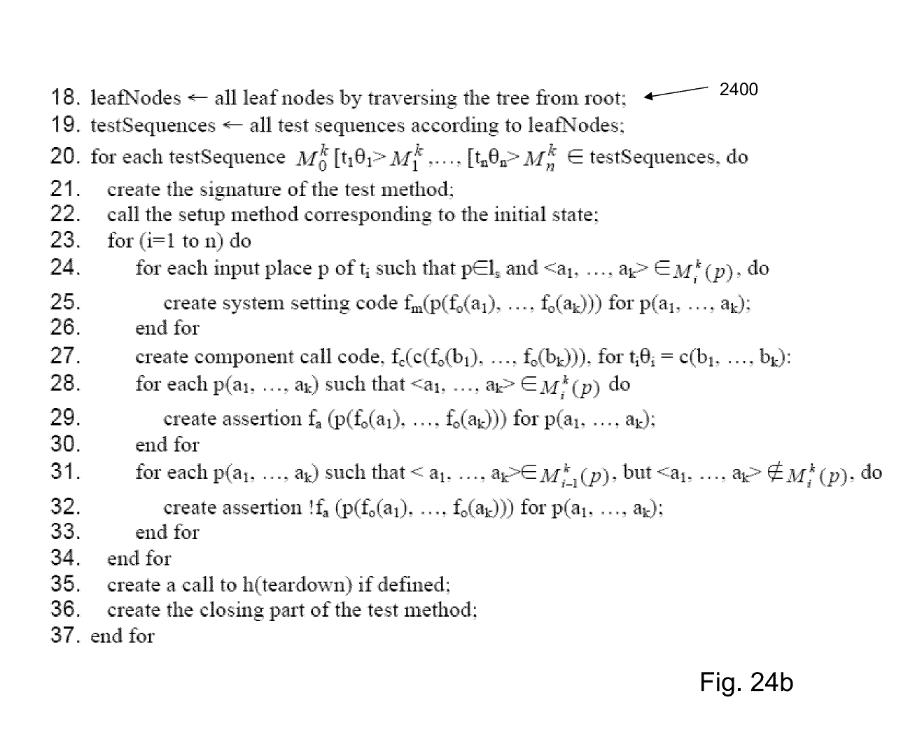

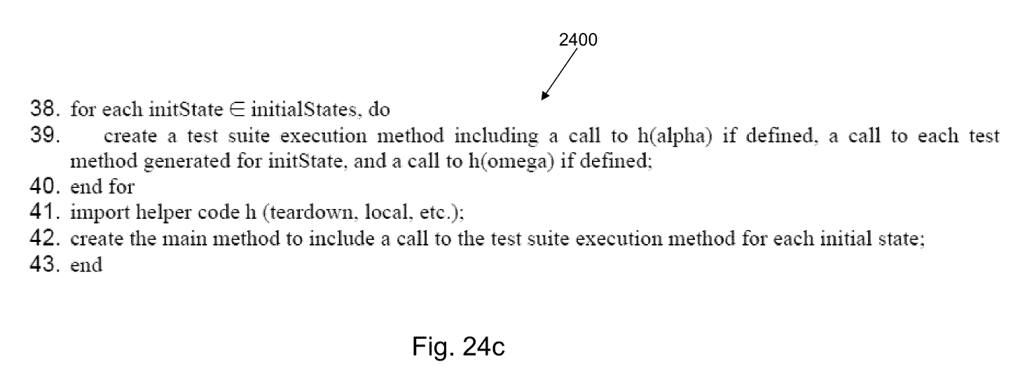

A first algorithm 2400 is shown in FIGS. 24a-24c, in accordance with an illustrative embodiment, to describe how a test class for an entire transition tree is generated for an object-oriented language (e.g., Java, C#, C++, and VB). The header (e.g., package and import statements in Java) and the signature of the test class (lines 2-3) are created. When the AUT 224 is a class or a cluster of classes, the declaration of an instance variable whose type is ID (lines 4-6) is also created. For each initial state, a setup method is generated to set the AUT 224 to the given state by using the mutator function (lines 7-17) (when there are no user-provided setup methods). Given a token p (a₁, a₂, . . . , aₖ), in an initial state, model-level objects aᵢ are transformed to implementation-level objects ƒₒ(aᵢ) and the mutator function ƒₘ (line 14) is called. This is similar for dealing with system settings in test sequences (line 25). For each test sequence retrieved from the tree, the algorithm generates a test method (lines 20-37). The body of the test method first invokes the corresponding setup method (line 22), and then for each call in the sequence, configures the system settings for the call (lines 24-26), issues the call (line 27), and verifies oracle values of the call (lines 28-33, refer to the definitions of oracle values in Section 4). For component call tᵢθᵢ=c(b₁, b₂, . . . , bₖ), the algorithm transforms model-level objects bᵢ to implementation-level objects ƒₒ(bᵢ) and then calls the component function ƒ_{c} (line 27). Mapping of objects also applies to the generation of assertions for oracles before the accessor function ƒₐ is used (lines 29 and 32). The test method also calls the teardown code if defined (line 35). After all test methods are completed, the test suite method for each initial state is created to execute the alpha code if defined, invoke each test method, and perform the omega code if defined (lines 38-40). Finally, the algorithm imports the user-defined code (line 41) and creates the main method (line 42). When a test framework such as JUnit and NUnit is used, the following parts are not needed: (1) the calls to the setup and teardown methods in each test method; (2) the test suite methods; and (3) the main method. When the target language is HTML for Selenium IDE, an HTML header is used, output each test sequence to an HTML file (as a Selenium test), include the setup and teardown code directly in each test sequence, and output the test suite code to an HTML file with a hyperlink to each individual test. After the test suite code is loaded into Selenium IDE, the tests can be executed automatically.

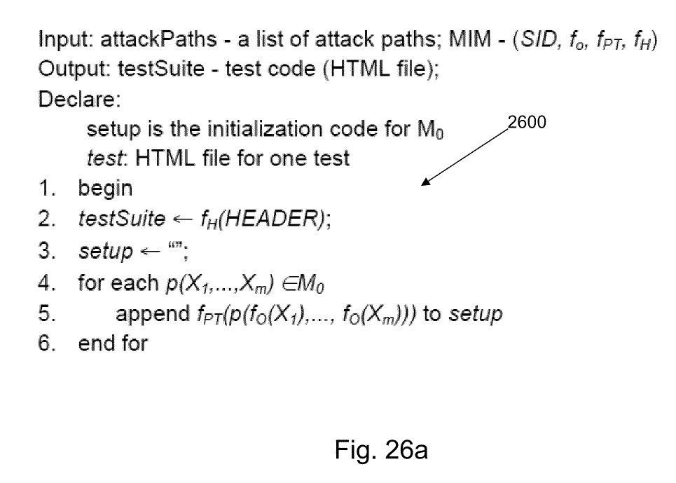

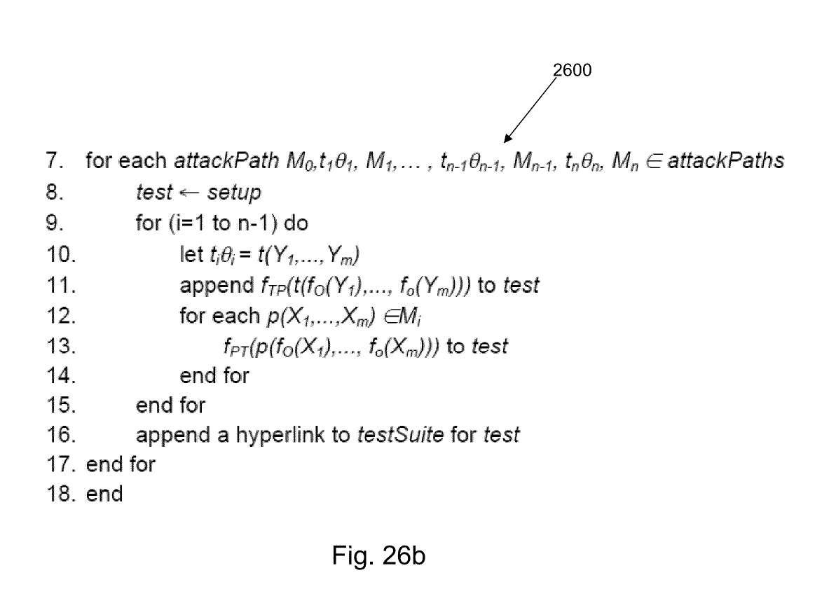

Algorithm HTML/Selenium test code consists of one or more HTML files, depending on whether or not a separate file is generated for each test or a single file includes all of the tests in the test tree. If a separate file is generated for each test, an HTML file for the test tree is generated. It includes a hyperlink to each test case file. The test suite file may be opened to execute the tests. The setup and teardown code is inserted into the beginning and end of each test, respectively. The alpha/omega code is inserted into the beginning/end of the test suite, respectively. A third algorithm 2600 is shown in FIGS. 26a-26b, in accordance with an illustrative embodiment, to describe how the test suite in HTML/Selenium is generated from the attack paths 2200 according to the MIM specification.

The structure of C test code in a single file consists of the following portions: a header (#include etc.) from the helper code, a setup method from the helper code, a teardown method from the helper code, an assert function, a function for each test according to the specifications of objects, methods, accessors, and mutators in MIM, code segments from the helper code, a test suite method (the testAll method) that invokes the alpha code in the helper code, each test method, and the omega code in the helper code, and a test driver (i.e., the main method). A definition of the assert function may be included in the #include part of the helper code.

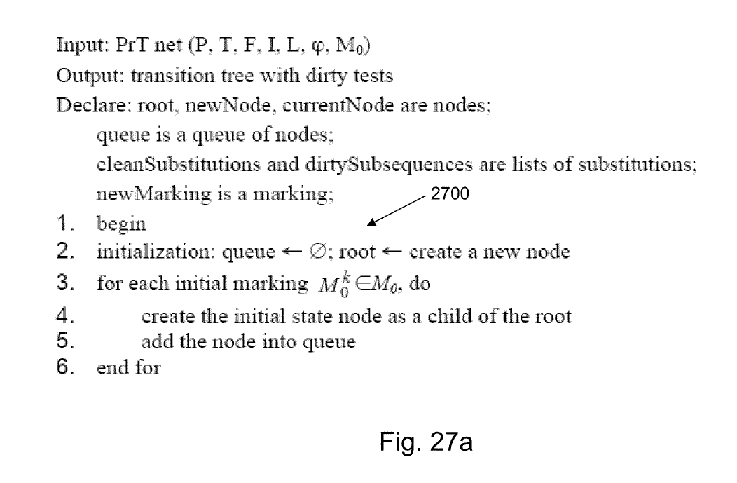

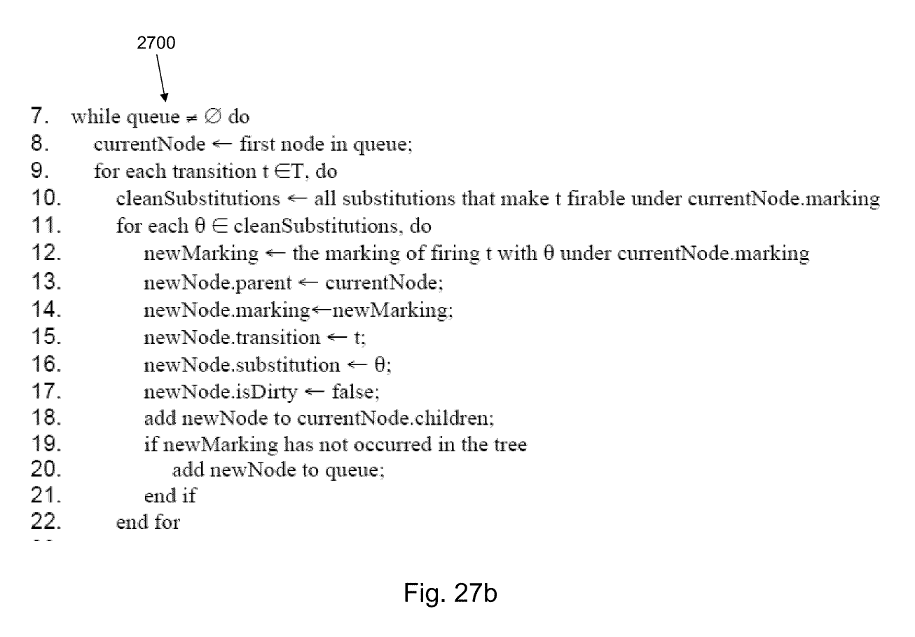

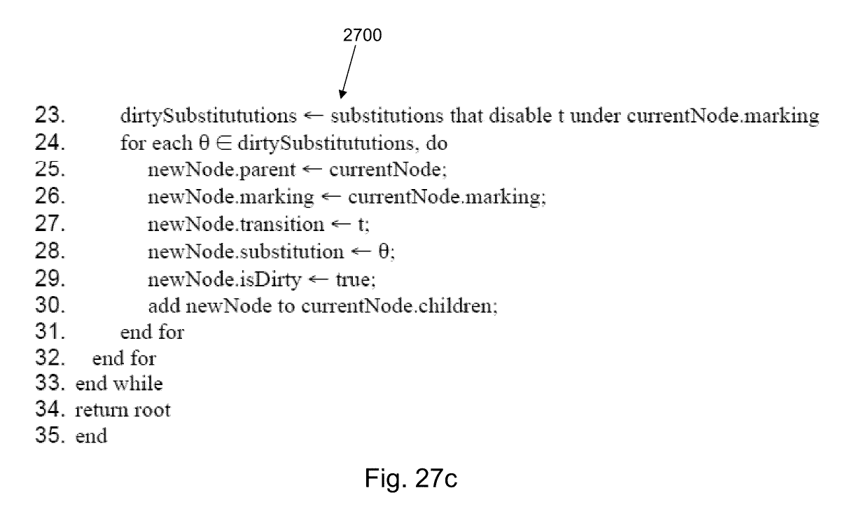

A fourth algorithm 2700 is shown in FIGS. 27a-27c, in accordance with an illustrative embodiment, to describe how to generate test sequences for reachability coverage with dirty tests. In a reachability graph, nodes represent unique states and thus there can be cycles (e.g., in FIG. 3). To facilitate generating test sequences, fourth algorithm 2700 transforms a reachability graph to a tree by allowing a marking to be contained in different nodes so as to remove cycles in the reachability graph. Each edge, i.e., transition firing (mᵢ,tθ,mⱼ), in the reachability graph is retained in the tree. In the transition tree, each node contains references to the parent node, firing (transition and substitution), current marking resulted from the firing, and a list of children. A leaf node is a node without children. It implies a test sequence, i.e., a sequence of nodes (transition firings and resultant markings), starting from the corresponding initial marking node to the leaf. Fourth algorithm 2700 uses the breadth-first search and includes the generation of dirty test sequences. Each node includes a variable is Dirty to indicate whether the sequence is a dirty test.

After initialization, fourth algorithm 2700 creates a node for each initial marking and adds the node to the queue for expansion (lines 3-6). Then, fourth algorithm 2700 takes a node from the queue for expansion (line 8). For each transition, fourth algorithm 2700 finds all substitutions that enable the transition under the marking of the current node (called clean substitutions, line 10), creating a successor node through the transition firing for each substitution (lines 12-18), and putting the new node into the queue for further expansion if the state has not appeared before (line 19-21). Substitutions are computed through unification and backtracking techniques based on the definition of transition enabledness. A clean substitution for a transition is obtained by unifying the arc label of each input or inhibitor place with the tokens in this place and evaluating the guard condition (an inhibitor arc indicates negation, though). After a substitution is obtained, backtracking is applied to the unification process until all clean substitutions are found.

Computing clean and dirty substitutions is a process of finding actual parameters of variables to dynamically determine state transitions so that complete test sequences can be generated. fourth algorithm 2700 returns the root of the transition tree so that the tree can be traversed for test code generation (line 34). In a transition tree, each leaf node indicates a test sequence, starting from its corresponding initial state node to the leaf node. All the sequences generated from the same initial state constitute a test suite. Therefore, a transition tree contains one or more test suites.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, the use of “and” or “or” is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A computer-readable medium having stored thereon computer-readable instructions that when executed by a computing device cause the computing device to:
receive an indicator of an interaction by a user with a user interface window presented in a display of the computing device, wherein the indicator indicates that a test model definition is created;
control presentation of a mapping window in the display, wherein the mapping window includes a first column and a second column;
receive an event identifier in the first column and text mapped to the event identifier in the second column, wherein the event identifier defines a transition included in the test model definition and the text defines code implementing a function of a system under test associated with the transition in the mapping window;
control presentation of a code window in the display, wherein helper code text is entered in the code window;
receive the helper code text, wherein the helper code text defines second code to generate executable code from the code implementing the function of the system under test; and
generate executable test code using the code implementing the function of the system under test and the second code.

2. The computer-readable medium of claim 1, wherein the test model definition is defined as a function net.

3. The computer-readable medium of claim 1, wherein the test model definition is defined as a unified modeling language state machine.

4. The computer-readable medium of claim 1, wherein the test model definition is defined as a set of contracts, which include a precondition and a postcondition.

5. The computer-readable medium of claim 1, wherein the computer-readable instructions are further configured to receive a second indicator of an interaction by the user with the user interface window presented in the display of the computing device, wherein the second indicator indicates an identity of the system under test.

6. The computer-readable medium of claim 5, wherein the identity is a class name, a function name, or a uniform resource locator.

7. The computer-readable medium of claim 1, wherein the computer-readable instructions are further configured to:
receive a second indicator, wherein the second indicator indicates user selection of a generate test tree selector; and
generate a test tree after receipt of the second indicator, wherein the test tree is created based on the test model definition and a coverage criterion selection.

8. The computer-readable medium of claim 7, wherein the coverage criterion selection is selectable by the user from a plurality of test coverage options.

9. The computer-readable medium of claim 8, wherein the generated test tree includes a plurality of test sequences, wherein a test sequence includes a test input and an assertion included in the generated executable test code, wherein the assertion compares an actual state of the system under test against an expected state to determine whether the test sequence passes or fails.

10. The computer-readable medium of claim 9, wherein the helper code text includes at least one of setup code or teardown code, wherein the setup code is executed once at the beginning of each test sequence of the plurality of test sequences and the teardown code is executed once at the end of the of each test sequence of the plurality of test sequences.

11. The computer-readable medium of claim 9, wherein the helper code text includes at least one of alpha code or omega code, wherein the alpha code is executed once at the beginning of the generated executable test code and the omega code is executed once at the end of the generated executable test code.

12. The computer-readable medium of claim 9, wherein the helper code text includes import code, wherein the import code includes a variable declaration and is executed once as part of initialization of the generated executable test code.

13. The computer-readable medium of claim 9, wherein the helper code text includes header code, wherein the header code is executed once as part of creation of the generated executable test code.

14. The computer-readable medium of claim 7, wherein the coverage criterion selection is selected from the group including reachability tree coverage, reachability coverage plus invalid paths, transition coverage, state coverage, depth coverage, random generation, goal coverage, assertion counter examples, deadlock/termination state coverage, and generation from given sequences.

15. The computer-readable medium of claim 1, wherein the generated executable test code is in a computer language selectable by the user from a plurality of computer programming languages presented in the user interface window.

16. The computer-readable medium of claim 15, wherein the generated executable test code is ready for compilation by a compiler based on the selected computer language.

17. The computer-readable medium of claim 1, wherein the computer-readable instructions are further configured to:
control presentation of a second mapping window in the display, wherein the second mapping window includes a first column and a second column; and
receive an object identifier in the first column of the second mapping window and second text mapped to the object identifier in the second column of the second mapping window, wherein the object identifier defines a test object included in the test model definition and the second text defines code implementing the test object in the test model;
wherein the generated executable test code uses the second text.

18. The computer-readable medium of claim 1, wherein the computer-readable instructions are further configured to:
control presentation of a third mapping window in the display, wherein the third mapping window includes a first column and a second column; and
receive a model level state identifier in the first column of the third mapping window and third text mapped to the model level state identifier in the second column of the third mapping window, wherein the model level state identifier defines an expected value included in the test model definition and the second text provides a method for comparing the expected value to an actual value to verify that a state of the system under test is correct or not;
wherein the generated executable test code uses the third text.

19. A system comprising:
a processor;
a display operably coupled to the processor; and
a computer-readable medium operably coupled to the processor, the computer-readable medium having computer-readable instructions stored thereon that, when executed by the processor, cause the system to
receive an indicator of an interaction by a user with a user interface window presented in the display, wherein the indicator indicates that a test model definition is created;
control presentation of a mapping window in the display, wherein the mapping window includes a first column and a second column;
receive an event identifier in the first column and text mapped to the event identifier in the second column, wherein the event identifier defines a transition included in the test model definition and the text defines code implementing a function of a system under test associated with the transition in the mapping window;
control presentation of a code window in the display, wherein helper code text is entered in the code window;
receive the helper code text, wherein the helper code text defines second code to generate executable code from the code implementing the function of the system under test; and
generate executable test code using the code implementing the function of the system under test and the second code.

20. A method of creating test code automatically from a test model, the method comprising:
receiving an indicator of an interaction by a user with a user interface window presented in a display of a computing device, wherein the indicator indicates that a test model definition is created;
controlling presentation of a mapping window in the display, wherein the mapping window includes a first column and a second column;
receiving an event identifier in the first column and text mapped to the event identifier in the second column, wherein the event identifier defines a transition included in the test model definition and the text defines code implementing a function of a system under test associated with the transition in the mapping window;
controlling presentation of a code window in the display, wherein helper code text is entered in the code window;
receiving the helper code text, wherein the helper code text defines second code to generate executable code from the code implementing the function of the system under test; and
generating executable test code using the code implementing the function of the system under test and the second code.
